(19) United States
(12) Patent Application Publication
(10) Pub. No.: US 2026/0019982 A1
(43) Pub. Date: Jan. 15, 2026

(54) POSITIONING WITH ESTIMATED MEASUREMENTS

(71) Applicant: InterDigital Patent Holdings, Inc., Wilmington, DE (US)

(72) Inventors: Fumihiro Hasegawa, Westmount (CA); Kunjan Shah, London (GB); Yugeswar Deenoo Narayanan Thangaraj, Chalfont, PA (US); Paul Marinier, Brossard (CA); Tuong Hoang, Montreal (CA); Jaya Rao, Montreal (CA); Janet Stern-Berkowitz, Little Neck, NY (US); Patrick Tooher, Montreal (CA)

(73) Assignee: InterDigital Patent Holdings, Inc., Wilmington, DE (US)

(21) Appl. No.: 18/992,003

(22) PCT Filed: Jul. 19, 2023
(86) PCT No.: PCT/US23/28127

§ 371 Date: Jan. 7, 2025

Related U.S. Application Data
(60) Provisional application No. 63/390,440, filed on Jul. 19, 2022.
(60) Provisional application No. 63/444,638, filed on Feb. 10, 2023.
(60) Provisional application No. 63/465,052, filed on May 9, 2023.

(51) Int. Cl. H04W 64/00; H04L 5/00; H04W 24/10

(52) U.S. Cl. CPC H04W 64/00; H04L 5/0048; H04W 24/10

(57) ABSTRACT

Systems, methods, and/or apparatuses are provided herein for positioning devices in a network using estimated measurements. A wireless transmit/receive unit (WTRU) may determine positioning accuracy based on one or more actual and/or inferred measurements. The WTRU or a network entity may train and/or implement one or more artificial intelligence (AI) and/or machine learning (ML) models to determine the positioning accuracy.

### CROSS-REFERENCE TO RELATED APPLICATION

This application claims priority to U.S. Provisional Patent Application No. 63/390,440 filed in the United States of America on Jul. 19, 2022, to U.S. Provisional Patent Application No. 63/444,638 filed in the United States of America on Feb. 10, 2023, and to U.S. Provisional Patent Application No. 63/465,052 filed in the United States of America on May 9, 2023, the entire contents of each of which are incorporated herein by reference.

### BACKGROUND

Downlink positioning methods, uplink positioning methods, and/or combined downlink and uplink positioning methods may be described and/or used herein with respect to positioning. One or more of the methods described herein may use a positioning reference signal and/or a sounding reference signal for positioning. The environment may play a (e.g., critical) role in the measurement of the positioning reference signal and/or the sounding reference signal, which may (e.g., subsequently) impact (e.g., achievable) positioning accuracy by one or more of the positioning techniques described herein.

### SUMMARY

A WTRU may be unable to obtain and/or measure one or more measurements, for example, based on WTRU capability and/or (e.g., lack of) one or more types of configured positioning method (e.g., angle-based, timing-based, WTRU-based, etc.). For example, depending on the configured positioning method, one or more (e.g. certain) positioning methods (e.g., angle-based positioning method such as downlink (DL)-angle of arrival (AoA), timing-based positioning method(s) such as DL-time difference of arrival (TDOA), network based positioning methods, WTRU-based positioning method(s), etc.). may not be available at a wireless transmit/receive unit (WTRU). For example, when the WTRU is configured with angle-based positioning, the WTRU may not obtain one or more timing measurements due to limited WTRU capabilities (e.g., the WTRU may not be capable of measuring timing). Additionally or alternatively, the WTRU may not receive one or more configurations related to timing synchronization between transmission-reception points (TRPs), which may prevent the WTRU from calculating an accurate reference signal time difference (RSTD). The WTRU may obtain one or more unobservable measurements. One or more measurements that cannot be measured by the WTRU (e.g., due to limited WTRU capability, unconfigured positioning reference signals (PRS(s)), one or more different time instances, and/or unconfigured TRPs) may be referred to as unobservable measurements and/or unobserved measurements herein. Additionally or alternatively, the WTRU may (e.g., only) perform one or more measurements on a PRS transmitted from configured TRPs, and/or the amount of one or more measurements may be limited to achieve a target accuracy.

Measurements may include one or more anomalies (e.g., non-line of sight (NLOS), unexpected timing errors, etc.). Thus, the WTRU may detect one or more (e.g., abnormal) measurements to isolate one or more error sources (e.g., timing error) that caused the one or more abnormalities. A WTRU with reduced capabilities (e.g., reduced bandwidth (BW), reduced number of antenna elements, etc.) may collect one or more measurements that may not be reliable (e.g., large variation in RSTD and/or large variation in one or more reference signal received power (RSRP) measurements). The WTRU may enhance the quality of the one or more measurements for reduced capability (RedCap) WTRUs to improve the accuracy of positioning.

The WTRU may determine an estimation (e.g., RSTD) based on one or more actual measurements (e.g., RSRP). The WTRU may receive one or more configurations from the network to determine the estimation. The WTRU may send a request to the network for one or more configurations to enable the function which generates the estimation, for example, based on one or more conditions herein (e.g., if at least one condition is satisfied); the input of the function may include one or more measurements made by the WTRU. For example, the WTRU may send the request to the network if the maximum RSRP among the PRS(s) is below a threshold and/or if the WTRU receives an indication from the network to determine an estimation of unobservable measurements (e.g., RSTD). The WTRU may determine its location based on (e.g., both) the estimated and/or actual measurement. Based on the difference between actual and inferred/estimated measurements, the WTRU may determine whether one or more errors are present in the one or more measurements. The WTRU may determine a first location estimate (e.g., absolute position) based on, for example, the one or more actual measurements. The WTRU may determine a second location estimate (e.g., absolute position) based on, for example, the one or more inferred measurements obtained based on the one or more actual measurements. The WTRU may report the first location and/or the relative location of the second location with respect to the first location. If the WTRU is configured with WTRU-based positioning, for example, the WTRU may report the determined location to the network, indicating that the estimation is used. If the WTRU is configured with WTRU-assisted positioning, for example, the WTRU may report both estimation and measurements to the network. The WTRU may determine the RSTD based on RSRP measurements and/or an artificial intelligence/machine learning (AI/ML) model, where the AI/ML model may be trained with one or more ideal measurements. The WTRU may indicate quality metrics of the one or more estimated measurements in the measurement report.

The WTRU may determine the estimated measurement (e.g., RSTD) based on the first measurement (e.g., RSRP). The WTRU may determine a difference (e.g., absolute value of a difference between two values) between the estimated measurement and second measurement (e.g., RSTD) and/or actual measurement. If the difference is above a preconfigured threshold, the WTRU may send a request to the network to change the PRS configuration. The WTRU may determine one or more anomalies, for example, by using an AI/ML model specifically configured for anomaly detection.

A WTRU may receive configuration information, for example, where the configuration information indicates positioning reference signal (PRS) configuration information for one or more (e.g., each) of a plurality of transmission/reception points (TRPs). The configuration information may indicate one or more criteria for requesting PRS measurement assistance information. The configuration information may indicate a minimum number of TRPs for which one or more PRS measurements are to be reported. The WTRU may determine at least one criteria of the one or more criteria for requesting the PRS measurement assistance information is satisfied based on one or more measurements performed on one or more of the plurality of TRPs. The WTRU may send a request for the PRS measurement assistance information. The request may indicate a location of the WTRU, for example, that is determined based on one or more measurements performed on one or more of the plurality of TRPs. The WTRU may receive the PRS measurement assistance information. The WTRU may estimate one or more measurements for at least one TRP based on the PRS measurement assistance information and/or at least one measurement performed using the PRS configuration information for at least one TRP of the plurality of TRPs. The WTRU may send a positioning measurement report. The positioning measurement report may include a set of one or more PRS measurements performed on a first subset of TRPs of the plurality of TRPs and/or a set of estimated measurements determined for a second subset of TRPs of the plurality of TRPs. For example, a total number of TRPs may be included in the first and/or second subset(s) of TRPs. For example, the total number of TRPs included in the first and/or second subset(s) of TRPs may be at least the minimum number of TRPs for which PRS measurement(s) are to be reported.

The WTRU may determine an estimated measurement of a first type of measurement, for example, based on one or more actual measurements of a second type of measurement and/or the PRS measurement assistance information. The WTRU may determine one or more estimated measurements of a relatively lower estimated quality for at least one additional TRP such that the total number of TRPs associated with actual PRS measurements, associated with the estimated measurements of a relatively higher estimated quality, and/or the estimated measurements of the relatively lower estimated quality is at least the minimum number of TRPs for which one or more measurements are to be reported. The determination of one or more estimated measurements of a relatively lower estimated quality for at least one additional TRP may be responsive to a determination that a total number of TRPs associated with one or more actual PRS measurements and/or associated with one or more estimated measurements of a relatively higher estimated quality are less than the minimum number of TRPs for which PRS measurements are to be reported.

The WTRU may request PRS measurement assistance information based on a determination that one or more of the plurality of TRPs includes non-line of sight TRPs.

The WTRU may determine a Reference Signal Time Difference (RSTD) based on, for example, one or more reference signal received power (RSRP) measurements and/or the PRS measurement assistance information.

The WTRU may receive an indication of a time window, and/or may send a first measurement report and/or a second measurement report, for example, based on the time window. The WTRU may estimate one or more measurements for at least one TRP based on one or more artificial intelligence (AI) and/or machine learning (ML) models. The WTRU may receive one or more parameters for the AI/ML model.

The WTRU may determine one or more anomalies associated with the set of PRS measurements performed on the first subset of TRPs of the plurality of TRPs and/or the set of estimated measurements determined for the second subset of TRPs of the plurality of TRPs. The WTRU may send an indication to a network indicating the one or more anomalies associated with the set of PRS measurements performed on the first subset of TRPs of the plurality of TRPs and/or the set of estimated measurements determined for the second subset of TRPs of the plurality of TRPs. The WTRU may send a request to update the PRS measurement assistance information to estimate one or more measurements for at least one TRP.

### BRIEF DESCRIPTION OF THE FIGURES

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2A is a schematic illustration of an example system environment that may implement an artificial intelligence (AI) and/or machine learning (ML) model.

FIG. 2B illustrates an example of a neural network.

FIG. 2C is a schematic illustration of an example system environment for training and/or implementing an AI/ML model that includes a neural network (NN).

FIG. 3 shows an example of the network training an AI/ML model based on measurements reported by a WTRU.

FIG. 4 shows an example system of a WTRU receiving one or more AI/ML parameters (e.g., weights) from a network entity (e.g., LMF).

FIG. 5 illustrates an example of inference generation using a system.

FIG. 6 illustrates an example signal flowchart between a WTRU, a gNB, and a location management function (LMF).

FIG. 7 shows an example system for enabling RSTD prediction based on one or more actual RSTD measurements.

FIG. 8A illustrates an example system of a predictable area where the reference TRP is TRP1.

FIG. 8B illustrates an example system of determining whether TRPs are within the coverage area of prediction/inference, where the center of the coverage is the location of the WTRU.

FIG. 9 illustrates an example system showing time of arrival in the presence of a reflected signal.

FIG. 10 shows example graphs of the estimate for time of arrival using a narrowband PRS and a wideband PRS.

FIG. 11 shows an example system for training an AI/ML model to generate inference.

FIG. 12 shows an example system illustrating inference generation from a trained model (e.g., AI/ML model).

FIG. 13 illustrates an example system for anomaly detection.

FIG. 14 illustrates an example process of use of AI for anomaly detection.

FIG. 15 illustrates an example system for network-assisted anomaly detection.

FIG. 16 illustrates an example system including a WTRU and a network entity (e.g., LMF) from which requests may be made for receiving assistance information.

FIG. 17 illustrates an example system in which a WTRU may determining (e.g., estimate) one or more RSRP measurements of unobserved TRP(s).

FIG. 18 illustrates an example system in which a WTRU may determine one or more RSRP measurements for one or more unobserved TRPs (e.g., in an extended area).

FIG. 19 depicts a process flowchart diagram of an example procedure to determine one or more measurements and/or one or more location measurements.

### EXAMPLE NETWORKS FOR IMPLEMENTATION OF THE INVENTION

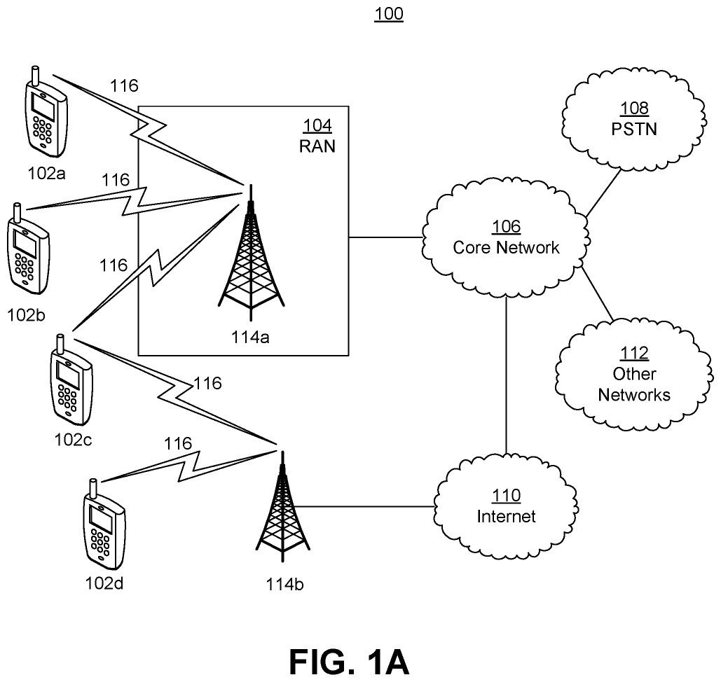

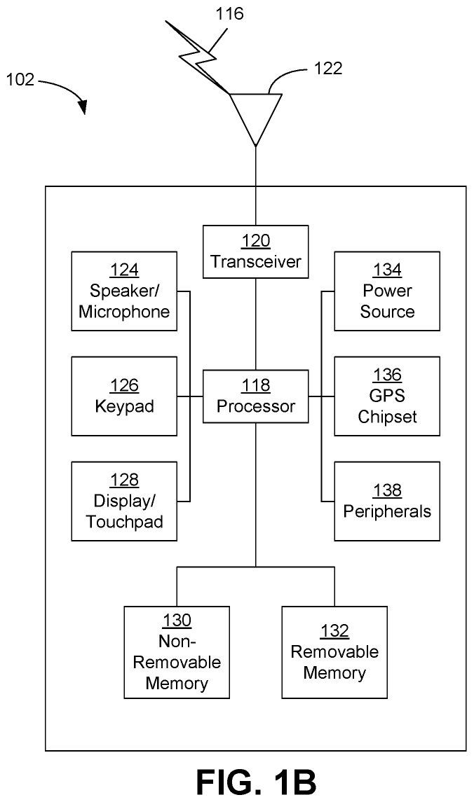

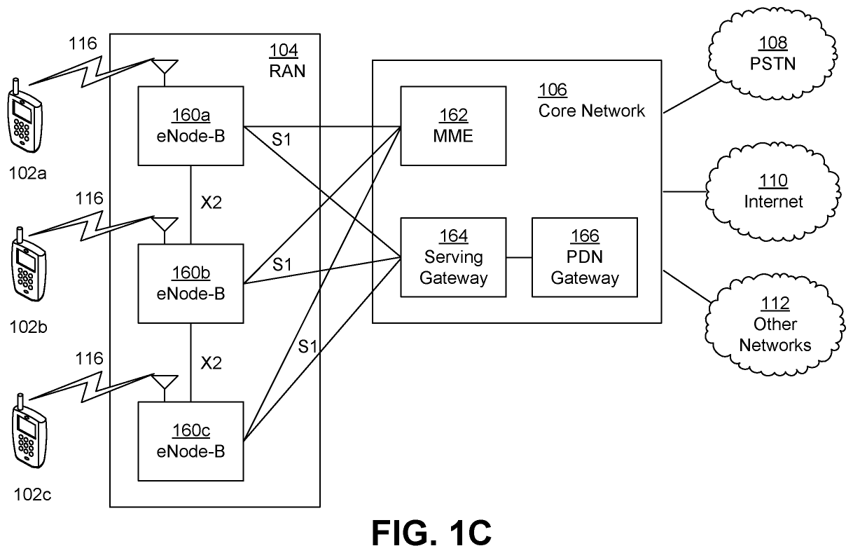

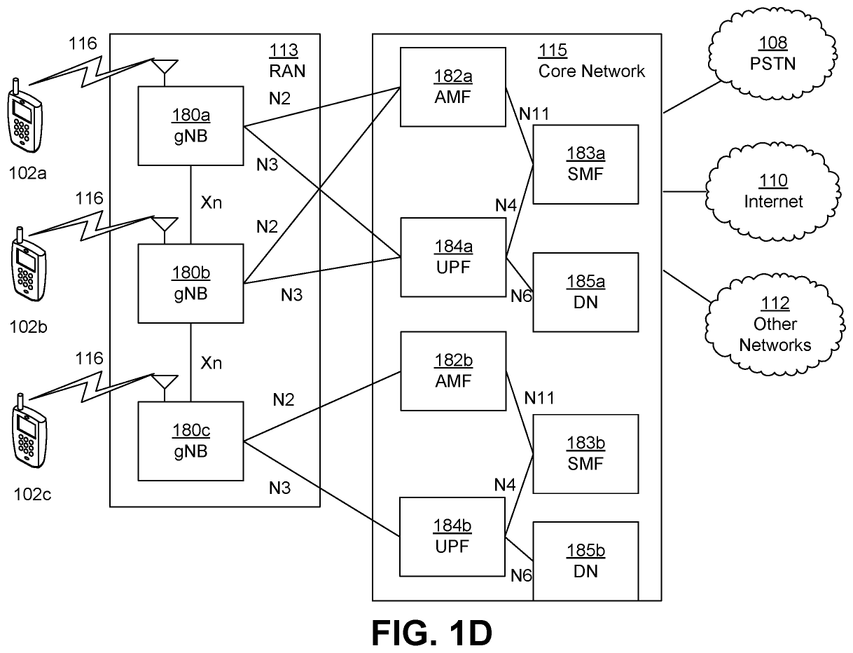

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data. Downlink (DL) positioning methods, uplink positioning methods, and/or combined downlink and uplink positioning methods may be used herein. For example, the one or more measurements may be used (e.g., by the WTRU and/or by the network), as described herein, to determine location information. The one or more measurements may be used to determine the location estimate (e.g., of the WTRU) using one or more AI/ML models as described herein. As used herein, the term downlink positioning method and/or DL positioning method may refer to one or more (e.g., any) positioning method that uses downlink reference signals such as a positioning reference signal (PRS). The WTRU may receive one or more (e.g., multiple) reference signals from transmission point(s) (TP(s)) and/or may measure DL reference signal time difference (RSTD) and/or reference signal received power (RSRP). Examples of DL positioning methods may include downlink-angle of departure (DL-AoD) and/or downlink-time difference of arrival (DL-TDOA) positioning. The RSTD may be determined based on the difference between time of arrival of reference PRS and target PRS where the WTRU is configured with the reference PRS and target PRS (e.g., which TRP may transmit the reference and/or target PRS, one or more PRS configurations for target and/or reference PRS). For WTRU-based DL-TDOA or DL-AoD, for example, the WTRU may return a location estimate of the WTRU to the network. The WTRU may determine its location, for example using one or more RSRP measurements and/or one or more RSTD measurements. For network based DL-TDOA or DL-AoD, for example, the WTRU may return one or more measurements (e.g., RSRP of received PRS, RSTD determined based on time of arrival of target PRS and reference PRS) to the network. The network may determine the location of the WTRU, for example, using one or more reported measurements (e.g., one or more RSRP measurements and/or one or more RSTD measurements).

As used herein, the term uplink (UL) positioning method and/or UL positioning method may refer to one or more (e.g., any) positioning methods that uses one or more uplink reference signals such as sounding reference signals (SRS) for positioning (SRSp) and/or SRS. The WTRU may transmit SRS to one or more (e.g., multiple) reception points (RPs) and/or the one or more RPs may measure the UL relative time of arrival (RTOA) and/or RSRP. Examples of UL positioning methods may include uplink-time difference of arrival (UL-TDOA) and/or uplink-angle of arrival (UL-AoA) positioning. The network may determine the location of the WTRU, for example, by using one or more measurements (e.g., RSRP, RTOA, difference between RTOAs) obtained from the received SRS and/or SRS for positioning.

As used herein, the term combined downlink and uplink positioning method and/or DL & UL positioning method may refer to one or more (e.g., any) positioning methods that use both uplink and downlink reference signals for positioning. For example, in round trip time (RTT) based positioning, the WTRU may receive PRS transmitted by one or more TRPs and/or may transmit SRS and/or SRS for positioning to the network. The WTRU may perform one or more measurements on received PRS and/or may determine reception (Rx)-transmission (Tx) time based on the transmission time of SRS and/or SRS for positioning and/or time of arrival of received PRS. In examples, a WTRU may transmit SRS to one or more (e.g., multiple) transmission/reception points (TRPs) and/or a network (e.g., gNB) may measure a reception (Rx) minus transmission (Tx) (e.g., Rx-Tx) time difference. The gNB may measure RSRP for the received SRS. The WTRU may measure the Rx-Tx time difference for PRS transmitted from one or more (e.g., multiple) TRPs. The WTRU may report the Rx-Tx time difference to the network. The Rx-Tx time may be defined by the difference between time of arrival of PRS and time that the WTRU transmits SRS and/or SRSp. The aforementioned time may be defined by: absolute time; relative time with respect to a reference; subframe number and/or subframe index; frame number and/or frame index; slot number and/or slot index; and/or symbol number or index. The WTRU may measure RSRP for the received PRS. The Rx-TX difference and/or possibly RSRP measured at WTRU and/or gNB may be used to compute round trip time. Here, Rx and Tx difference may refer to the difference between arrival time of the reference signal transmitted by the TRP and transmission time of the reference signal transmitted from the WTRU. An example of DL & UL positioning method may include multi-round trip time (multi-RTT) positioning. The network may determine the location of the WTRU, for example, using one or more reported measurements (e.g., RSRP, Rx-Tx time difference reported by the WTRU).

A PRS configuration may include one or more of the following: a PRS resource ID; a PRS sequence ID (e.g., and/or other ID(s) used to generate a PRS sequence); a PRS resource element offset; a PRS resource slot offset; a PRS symbol offset; PRS Quasi Colocation (QCL) information; a PRS resource set ID; a list of PRS resources in the resource set; one or more (e.g., a number of) PRS symbols; a muting pattern for PRS, muting parameters (e.g., a repetition factor), and/or muting options; a PRS resource power; a periodicity of PRS transmission; spatial direction information of a PRS transmission (e.g., beam information, one or more angles of transmission, etc.); spatial direction information of UL RS reception (e.g., beam ID used to receive UL RS, angle of arrival, etc.); a frequency layer ID, a TRP ID; and/or a PRS ID. For example, the QCL may indicate that one or more (e.g., two) RSs were transmitted through similar channels (e.g., the two RSs are transmitted from similar locations). In examples, spatial QCL may indicate that one or more (e.g., two) RSs were transmitted through one or more similar channels (e.g., the two RSs may be co-located).

An SRS for positioning (SRSp) configuration may include one or more of the following: a resource ID; comb offset values and/or a cyclic shift value; a start position in the frequency domain; one or more (e.g., a number of) SRSp symbols; a shift in the frequency domain for SRSp; a frequency hopping pattern; a type of the SRSp (e.g., aperiodic, semi-persistent, periodic, etc.); a sequence ID used to generate the SRSp (e.g., and/or other ID(s) used to generate the SRSp sequence); spatial relation information, indicating which reference signal (e.g., DL RS, UL RS, CSI-RS, SRS, DM-RS) and/or synchronization signal block (SSB) (e.g., SSB ID, cell ID of the SSB) the SRSp is related to spatially; QCL information (e.g., a QCL relationship between SRSp and other reference signals or SSB), QCL type (e.g., QCL type A, QCL type B, QCL type C, QCL type D); a resource set ID; a list of SRSp resources in the resource set; transmission power related information; pathloss reference information (e.g., which may include an index for SSB, CSI-RS, and/or PRS); a periodicity of the SRSp transmission; spatial direction information of SRSp transmission (e.g., beam information, angles of transmission, etc.); and/or spatial direction information of DL RS reception (e.g., beam ID used to receive DL RS, angle of arrival, etc.).

The embodiments described herein may implement artificial intelligence (AI) and/or machine learning (ML) algorithms (e.g., models). For example, a WTRU and/or a network may use one or more AI/ML models to determine the positioning (e.g., location) of a WTRU, one or more unobserved measurements and/or location of one or more TRPs (e.g., as described herein). As used herein, the term “artificial intelligence” and/or “AI” may include the behavior exhibited by one or more machines that mimic one or more cognitive functions (e.g., to sense, reason, adapt, and/or act). The terms unobserved and unobservable may be used interchangeably herein.

As used herein, the term “machine learning” and/or “ML” may refer to a type of algorithms that solve a problem based on learning through experience (“data”), without explicitly being programmed (“configuring set of rules”). Machine learning can be considered as a subset of AI. Different machine learning paradigms may be envisioned based on the nature of data and/or feedback available to the learning algorithm. For example, a supervised learning approach may involve learning a function that maps input to an output based on labeled training example, where one or more (e.g., each) training example may be a pair including input and the corresponding output. An unsupervised learning approach may involve detecting patterns in the data with no pre-existing labels. A reinforcement learning approach may involve performing sequence of actions in an environment to maximize the cumulative reward. In examples, it may be possible to apply one or more machine learning algorithms using a combination and/or interpolation of the approaches mentioned herein (e.g., above-mentioned approaches). For example, a semi-supervised learning approach may use a combination of a small amount of labeled data with a large amount of unlabeled data during training. In this regard, semi-supervised learning may fall between unsupervised learning (e.g., with no labeled training data) and supervised learning (e.g., with only labeled training data).

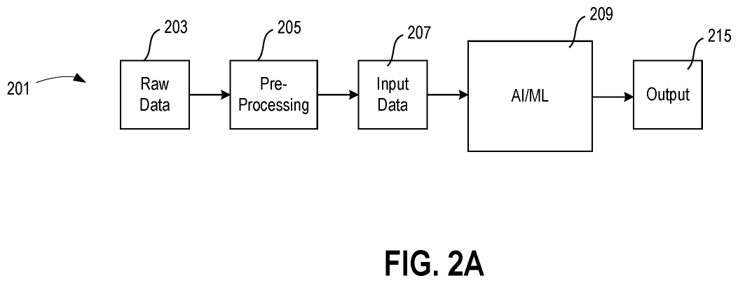

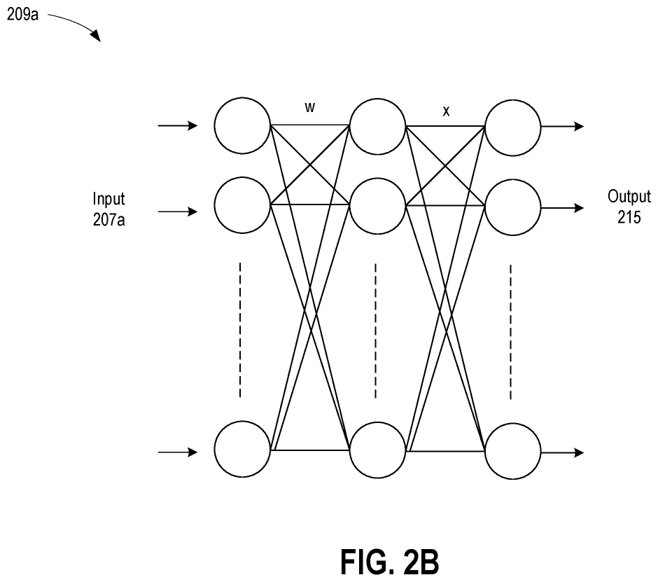

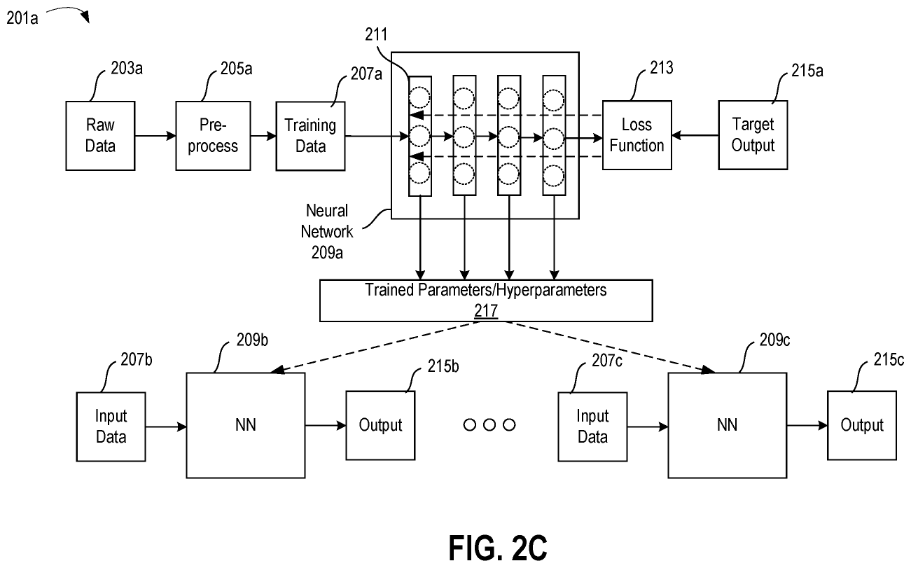

FIG. 2A is a schematic illustration of an example system environment 201 that may implement an AI/ML 209 model. The AI/ML model 209 may be implemented at the WTRU and/or the network (e.g., a location management function). The AI/ML 209 model may include model data and one or more algorithms and/or functions configured to learn from input data 207 that is received to train the AI/ML 209 and/or generate an output 215. The input data 207 may be input in one or more formats, such as an image format, an audio format (e.g., spectrogram or other audio format), a tensor format (e.g., including single-dimensional or multi-dimensional arrays), and/or another data type capable of being input into the AI/ML 209 algorithms. The input data 207 may be the result of pre-processing 205 that may be performed on raw data 203, or the input data 207 may include the raw data 203 itself. The raw data 203 may include image data, text data, audio data, or another sequence of information, such as a sequence of network information related to a communication network, and/or other types of data. The pre-processing 205 may include format changes or other types of processing (e.g., averaging, filtering in time, and/or frequency domain) in order to generate input data 207 in a format for being input into the AI/ML 209 algorithms. The output 215 may be generated by the AI/ML 209 algorithm in one or more formats, such as a tensor, a text format (e.g., a word, sentence, or other sequence of text), a numerical format (e.g., a prediction), an audio format, an image format (e.g., including video format), another data sequence format, or/another output format.

AI/ML 209 may be implemented as described herein using software and/or hardware. The AI/ML 209 may be stored as computer-executable instructions on computer-readable media accessible by one or more processors for performing as described herein. Example AI/ML environments and/or libraries include TENSORFLOW, TORCH, PYTORCH, MATLAB, GOOGLE CLOUD AI and AUTOML, AMAZON SAGEMAKER, AZURE MACHINE LEARNING STUDIO, and/or ORACLE MACHINE LEARNING.

The AI/ML 209 may include one or more algorithms configured for unsupervised learning. Unsupervised learning may be implemented utilizing AI/ML 209 algorithms that learn from the input data 207 without being trained toward a particular target output. For example, during unsupervised learning the AI/ML 209 algorithms may receive unlabeled data as input data 207 and determine patterns or similarities in the input data 207 without additional intervention (e.g., updating parameters and/or hyperparameters). The AI/ML 209 algorithms that are configured for implementing unsupervised learning may include algorithms configured for identifying patterns, groupings, clusters, anomalies, and/or similarities or other associations in the input data 207. For example, the AI/ML may implement hierarchical clustering algorithms, k-means clustering algorithms, k nearest neighbors (K-NN) algorithms, anomaly detection algorithms, principal component analysis algorithms, and/or apriori algorithms. The AI/ML 209 algorithms configured for unsupervised learning may be implemented on a single device or distributed across multiple devices, such that the output 215, or portions thereof, may be aggregated at one or more devices for being further processed and/or implemented in other downstream algorithms or processes, as may be further described herein.

The AI/ML 209 may include one or more algorithms configured for supervised learning. Supervised learning may be implemented utilizing AI/ML 209 algorithms that are trained during a training process to determine a predictive model using known outcomes. The AI/ML 209 algorithms may be characterized by parameters and/or hyperparameters that may be trained during the training process. The parameters may include values derived during the training process. The parameters may include weights, or coefficients, and/or biases. The AI/ML 209 may also include hyperparameters. The hyperparameters may include values used to control the learning process. The hyperparameters may include a learning rate, a number of epochs, a batch size, a number of layers, a number of nodes in each layer, a number of kernels (e.g., CNNs), a size of stride (e.g., CNNs), a size of kernels in a pooling layer (e.g., CNNs), and/or other hyperparameters. Some may use certain parameters and hyperparameters interchangeably.

The AI/ML 209 may be trained during supervised learning by inputting training data to the AI/ML 209 algorithm and adjusting the parameters and/or hyperparameters toward a known target output 215 while minimizing a loss or error in the output 215 generated by the AI/ML 209 algorithm. The raw data 203 may include or be separated into training data, validation data, and/or test data for training, validation, and/or testing, respectively, the AI/ML 209 algorithms during supervised learning. The training data, validation data, and/or test data may be pre-processed from the raw data 103 for being input into the AI/ML 209 algorithm. During supervised learning, the training data may be labeled prior to being input into the AI/ML 209. The training data may be labeled to teach the AI/ML 209 algorithm to learn from the labeled data and to test the accuracy of the AI/ML 209 for being implemented on unlabeled input data 207 during production/implementation of the AI/ML 209 algorithms, or similar AI/ML 109 algorithms utilizing similar parameters and/or hyperparameters. The training data may be used to fit the parameters of the AI/ML 209 model using optimization functions, such as a loss or error function. Often the training data includes pairs of input data 207 and a corresponding target output 215 to which the parameters may be trained to generate (e.g., within a threshold loss or error). The trained or fitted AI/ML 209 model may receive the validation data as input to evaluate the model fit on the training data set, while tuning the hyperparameters of the AI/ML 209 model. The AI/ML 209 model may receive the test data to evaluate a final model fit on the training data set and to assess the performance of the AI/ML 209 model. One or more of the training, validation, and/or testing may be performed during supervised learning for different types of AI/ML 209 models.

Supervised learning may be implemented for various types of AI/ML 209 algorithms, including algorithms that implement linear regression, logistic regression, neural networks (NNs), decision trees, Bayesian logics, random forests, and/or support vector machines (SVMs). NNs and Deep NNs (DNNs) are popular examples of algorithms utilized in AI/ML models that may be trained using supervised learning. However, the AI/ML 209 models may implement one or more NN and/or non-NN-based algorithms. Various examples of NNs include: perceptrons, multilayer perceptrons (MLPs), feed-forward NNs, fully-connected NNs, convolutional Neural Networks (CNNs), recurrent NNs (RNNs), long-short term memory (LSTM) NNs, and/or residual NNs (ResNets). A perceptron is a NN that includes a function that multiplies its input by a learned weight coefficient to generate an output value. A feed-forward NN is a NN that receives input at one or more nodes of an input layer and moves information in a direction through one or more hidden layers to one or more nodes of an output layer. In a feed-forward NN, one or more nodes of a given layer may be connected to one or more nodes of another layer. A fully connected NN is a NN that includes an input layer, one or more hidden layers, and an output layer. In a fully connected NN, each node in a layer is connected to each node in another layer of the NN. An MLP is a fully connected class of feed-forward NNs. A CNN is a NN having one or more convolutional layers configured to perform a convolution. Various types of NNs may have elements that include one or more CNNs or convolutional layers, such as Generative Adversarial Networks (GANs). GANs may include conditional GANs (CGANs), cycle-consistent GANs (CycleGANs), StyleGANs, DiscoGANs, and/or IsGANs. A GAN may include a generator sub-model and a discriminator sub-model. The generator sub-model may be configured to receive input data and pass true and independently generated data to the discriminator sub-model. The discriminator sub-model may be configured to receive the true and independently generated data from the generator, discriminate the true and independently generated data, and provide feedback to the generator sub-model during training to improve the function of the generator sub-model in independently generating an output based on a received input. The GAN is a popular model for generating data types or data sequences, such as image data, audio data, and/or text, for example. An RNN is a NN that is recurrent in nature, as the nodes include feedback connections and an internal hidden state (e.g., memory) that allows output from nodes in the NN to affect subsequent input to the same nodes. LSTM NNs may be similar to RNNs in that the nodes have feedback connections and an internal hidden state (e.g., memory). However, the LSTM NNs may include additional gates to allow the LSTM NNs to learn longer-term dependencies between sequences of data. A ResNet is a NN that may include skip connections to skip one or more layers of the NN. An autoencoder may be a form of AI/ML 109 that may be implemented for supervised learning, such that parameters and/or hyperparameters may be updated during a training procedure. The parameters and/or hyperparameters may relate to the encoder portion and/or the decoder portion of the autoencoder. Some NNs include one or more attention layers or functions to enhance or focus on some portions of the input data, while diminishing or de-emphasizing other portions.

Different types of NNs and/or layers may be implemented for processing different types of data and/or producing different types of output. For example, the NN may comprise one or more convolutional layers (e.g., for CNNs or GANs), which may be popular for processing image data and/or audio data (e.g., spectrograms). Each convolutional layer may vary according to various convolutional layer parameters or hyperparameters, such as kernel size (e.g., field of view of the convolution), stride (e.g., step size of the kernel when traversing an image), padding (e.g., for processing image borders), and/or input and output size. The image being processed may include one or more dimensions (e.g., a line of pixels or a two-dimensional array of pixels). The pixels may be represented according to one or more values (e.g., one or more integer values representing color and/or intensity) that may be received by the convolutional layer. The kernel, which may also be referred to as a convolution matrix or mask, may be a matrix used to extract and/or transform features from the input data being received. The kernel may be used for blurring, sharpening, edge detection, and/or the like. An example kernel size may include a 3×3, 5×5, 10×10, etc. matrix (e.g., in pixels for a 2D image). The stride may be the parameter used to identify the amount the kernel is moved over the image data. An example default stride is of a size of 1 or 2 within the matrix (e.g., in pixels for a 2D image). The padding may include the amount of data (e.g., in pixels for a 2D image) that is added to the boundaries of the image data when it is processed by the kernel. The kernel may be moved over the input image data (e.g., according to the stride length) and perform a dot product with the overlapping input region to obtain an activation value for the region. The output of each convolutional layer may be provided to a next layer of the NN or provided as an output (e.g., image data, feature map, etc.) of the NN itself with the updated features based on the convolution.

The NN may include layers of a similar type (e.g., convolutional layers, feed-forward layers, fully-connected layers, etc.) and/or having a similar or different configuration (e.g., size, number of nodes, etc.) for each layer. The NN may also, or alternatively, include one or more layers having different types or different subsets of NNs that may be interconnected for training and/or implementation, as described herein. For example, a NN may include both convolutional layers and feed-forward or fully-connected layers.

FIG. 2B illustrates an example of a neural network 209a. The objective of training may be to apply the input 207a as training data and/or adjust one or more weights, indicated as w and x in FIG. 2B (e.g., which may be referred to as neuron weights and/or link weights), such that the output 215 from the neural network 209a approaches the desired target values which are associated with the input 207a values for the training data. In examples, a neural network may include three layers (e.g., as shown in FIG. 2B). During the training, for given input, the difference between output and desired values may be computed and/or the difference may be used to update the one or more weights in the neural network. If a significant (e.g., large) difference between output and desired value(s) is observed, for example, one or more relatively significant (e.g., large) changes in one or more weights may be expected; a small difference (e.g., between output and desired value(s) may include one or more relatively small changes in one or more weights. For example, for positioning, the input 207a may be reference signal parameters and/or the output 215 may be an estimated position. The desired value may be location information acquired by global navigation satellite system (GNSS) with high accuracy.

Once the neural network 209a completes its training, the difference between the output 215 and desired values may be below a threshold. The neural network 209a may be applied or implemented after training for positioning by feeding input data 207a and/or by estimating or predicting the output 215 as the expected outcome for the associated input 207a. The output 215 may be an estimated position and/or location of the WTRU.

Training a neural network 209a may include identifying one or more of the following information: the input for the neural network; the expected output associated with the input; and/or the actual output from the neural network against which the target values are compared.

In examples, a neural network model may be characterized by one or more parameters and/or hyperparameters, which may include: the number of weights and/or the number of layers in the neural network.

As used herein, the term “deep learning” may refer to a class of machine learning algorithms that employ artificial neural networks (e.g., deep neural networks (DNNs)) which were loosely inspired from biological systems and/or include at least one hidden layer. DNNs may be a special class of machine learning models inspired by the human brain where the input is linearly transformed and/or pass through a non-linear activation function one or more (e.g., multiple) times. DNNs may include one or more (e.g., multiple) layers where one or more (e.g., each) layer includes linear transformation and/or a given non-linear activation function(s). The DNNs may be trained using the training data via a back-propagation algorithm. Recently, DNNs have shown state-of-the-art performance in variety of domains, e.g., speech, vision, natural language etc., and/or for various machine learning settings (e.g., supervised, unsupervised, and/or semi-supervised).

FIG. 2C is a schematic illustration of an example system environment 201a for training and implementing an AI/ML model that comprises an NN 209a. However, other types of AI/ML models (e.g., including NNs and/or non-NN models) may be similarly trained and/or implemented. The NN 209a may be trained and/or implemented on one or more devices to determine and/or update parameters and/or hyperparameters 217 of the NN 209a. Raw data 203a may be generated from one or more sources. For example, the raw data 203a may include image data, text data, audio data, or another sequence of information, such as a sequence of network information related to a communication network, and/or other types of data. The raw data 203a may be preprocessed at 205a (e.g., averaging, filtering in time, and/or frequency domain) to generate training data 207a. The preprocessing may include formatting changes or other types of processing in order to generate the training data 207a in a format for being input into the NN 209a.

The NN 209a may include one or more layers 211. The configuration of the NN 209a and/or the layers 211 may be based on the parameters and/or hyperparameters 217. As described herein, the parameters may include weights, or coefficients, and/or biases for the nodes or functions in the layers 211. The hyperparameters may include a learning rate, a number of epochs, a batch size, a number of layers, a number of nodes in each layer, a number of kernels (e.g., CNNs), a size of stride (e.g., CNNs), a size of kernels in a pooling layer (e.g., CNNs), and/or other hyperparameters. As described herein, the NN 109a may include a feed forward NN, a fully connected NN a CNN, a GAN, an RNN, a ResNet, and/or one or more other types of NNs. The NN 209a may be comprised of one or more different types of NNs or different layers for different types of NNs. For example, the NN 109a may include one or more individual layers having one or more configurations.

During the training process, the training data 207a may be input into the NN 209a and may be used to learn the parameters and/or tune the hyperparameters 217. The training may be performed by initializing parameters and/or hyperparameters of the NN 209a, generating and/or accessing the training data 207a, inputting the training data 207a into the NN 209a, calculating the error or loss from the output of the NN 209a to a target output 215a via a loss function 213 (e.g., utilizing gradient descent and/or associated back propagation), and/or updating the parameters and/or hyperparameters 217.

The loss function 213 may be implemented using backpropagation-based gradient updates and/or gradient descent techniques, such as Stochastic Gradient Descent (SGD), synchronous SGD, asynchronous SGD, batch gradient descent, and/or mini-batch gradient descent. Examples of loss or error functions may include functions for determining a squared-error loss, a mean squared error (MSE) loss, a mean absolute error loss, a mean absolute percentage error loss, a mean squared logarithmic error loss, a pixel-based loss, a pixel-wise loss, a cross-entropy loss, a log loss, and/or a fiducial-based loss. The loss functions may be implemented in accordance one or more quality metrics, such as a Signal to Noise Ratio (SNR) metric or another signal or image quality metric.

An optimizer may be implemented along with the loss function 213. The optimizer may be an algorithm or function that is configured to adapt attributes of the NN 209a, such as a learning rate and/or weights, to improve the accuracy of the NN 209a and/or reduce the loss or error. The optimizer may be implemented to update the parameters and/or hyperparameters 217 of the NN 209a.

The training process may be iterated to update the parameters and/or hyperparameters 217 until an end condition is achieved. The end condition may be achieved when the output of the NN 209a is within a predefined threshold of the target output 215a.

After the training process is complete, the trained NN 209a, or portions thereof, may be stored for being implemented by one or more devices. The trained NN 209a, or portions thereof, may be implemented in other downstream algorithms or processes, as may be further described herein. The trained NN 209a, or portions thereof, may be implemented on the same device on which the training was performed. The trained NN 209a, or portions thereof, may be transmitted or otherwise provided to another device for being implemented. For example, the NN 209b, 209c may include one or more portions of the trained NN 209a. The NN 209b and NN 209c receive respective input data 207b, 207c and to generate respective outputs 215b, 215c. The output 215b, 215c may be generated in one or more formats, such as a tensor, a text format (e.g., a word, sentence, or other sequence of text), a numerical format (e.g., a prediction), an audio format, an image format (e.g., including video format), another data sequence format, and/or another output format. The output 215b, 215c may be aggregated at one or more devices for being further processed and/or implemented in other downstream algorithms or processes, as may be further described herein.

Alternatively, or additionally, after the training process is complete, the trained parameters and/or tuned hyperparameters 217, or portions thereof, may be stored for being implemented by one or more devices. The trained parameters and/or tuned hyperparameters 217, or portions thereof, may be implemented in other downstream algorithms or processes, as may be further described herein. The trained parameters and/or tuned hyperparameters 217, or portions thereof, may be implemented on the same device on which the training was performed. The trained parameters and/or tuned hyperparameters 217, or portions thereof, may be transmitted or otherwise provided to another device for being implemented. For example, transmitted or otherwise provided to another device or devices that may implement the NN 209b, 209c based on the trained parameters and/or tuned hyperparameters 217. For example, the NN 209b, 209c may be constructed at another device based on the trained parameters and/or tuned hyperparameters 217, or portions thereof. The NN 209b and NN 209c may be configured from the parameters/hyperparameters 217, or portions thereof, to receive respective input data 207b, 207c and to generate respective outputs 215b, 215c. The output 215b, 215c may be generated in one or more formats, such as a tensor, a text format (e.g., a word, sentence, or other sequence of text), a numerical format (e.g., a prediction), an audio format, an image format (e.g., including video format), another data sequence format, and/or another output format. The output 215b, 215c may be aggregated at one or more devices for being further processed and/or implemented in other downstream algorithms or processes, as may be further described herein.

The AI/ML models and/or algorithms described herein may be implemented on one or more devices. For example, the AI/ML 209 may be implemented in whole or in part on one or more devices, such as one or more WTRUs, one or more base stations, and/or one or more other network entities, such as a network server. Example networks in which AI/ML may be distributed may include federated networks. A federated network may include a decentralized group of devices that each include AI/ML. As shown in FIG. 2C, the AI/ML 209b and AI/ML 209c may be distributed across separate devices. Though FIG. 2C shows two models (e.g., AI/ML 209b and AI/ML 209c), any number of models may be implemented across any number of devices. The AI/ML may be implemented for collaborative learning in which the AI/ML is trained across multiple devices. In another example, the AI/ML may be trained at a centralized location or device and one or more portions of the AI/ML, or trained parameters and/or tuned hyperparameters, may be distributed to decentralized locations. For example, updated parameters or hyperparameters may be sent to one or more devices for updating and/or implementing the AI/ML thereon.

AI/ML may be used to estimate positioning (e.g., location of the WTRU). For example, a WTRU and/or network may use AI/ML to estimate positioning (e.g., location of the WTRU). A WTRU and/or network may estimate positioning based on one or more measurements (e.g., one or more measurements made on received PRSs transmitted from one or more TRPs and/or based on the location of one or more TRPs). For example, the WTRU and/or network may train an AI/ML model, as described herein, based on one or more actual and/or estimated measurements. As used herein, the term network may include application management function (AMF), location management function (LMF), base station (e.g., gNB), and/or next-generation radio access network (NG-RAN).

The following pairs of terms may be used interchangeably: events and occasions; pre-configuration and configuration; non-serving gNB and neighbouring gNB; gNB and TRP; PRS and PRS resource; PRS(s) and PRS resource(s); PRS and DL-PRS or DL PRS; and/or measurement gap and measurement gap pattern. The aforementioned PRS(s) or PRS resource(s) may belong to one or more different PRS resource sets. A measurement gap pattern may include one or more parameters such as a measurement gap duration, a measurement gap repetition period, and/or a measurement gap periodicity.

A positioning reference unit (PRU) may be a WTRU or TRP whose location (e.g., altitude, latitude, geographic coordinate, and/or local coordinate) is known by the network (e.g., gNB, LMF). The one or more capabilities of the PRU may be the same as a WTRU or TRP (e.g., capable of receiving PRS and/or transmitting SRS and/or SRS for positioning, one or more return measurements, and/or transmit PRS). The one or more WTRUs acting as PRUs may be used by the network for one or more calibration purposes (e.g., correct unknown timing offset, correct unknown angle offset).

An LMF may be a non-limiting example of a node and/or entity (e.g., network node and/or entity) that may be used for and/or to support positioning. One or more (e.g., any) other nodes and/or entities may be substituted for the LMF.

AI may be a branch of science which solves problems by enabling one or more machines to mimic human behavior. ML may be a subset of artificial intelligence which focuses on solving problems by learning from data and/or making predictions. As used herein, AI and ML terms may be used interchangeably.

A mathematical model may be a mathematical equation that approximates a relationship between one or more variables (e.g., input) with another variable (e.g., output). A model may be created by one or more ML techniques.

Model training may include a procedure where a model is provided with input variables and/or output variables to learn from.

Model deployment may be a process of deploying a trained model in the real world to perform one or more predictions and/or estimate output(s). Model inference may be a process of providing input variable(s) to the model and/or predicting/calculating output. Model deployment and model inference terms may be used interchangeably herein.

Model monitoring may be a process of monitoring the accuracy of output prediction of a particular model. Model accuracy may be a metric to compare one or more different classification models (e.g., defined as a ratio of a number of correct predictions made by a model to the total sample size).

Model updating may be a procedure where one model is replaced by another model for prediction.

Depending on the configured positioning method, one or more (e.g., certain) types of methods may not be available at a given WTRU. For example, when the WTRU is configured with an angle-based positioning, the WTRU may not be able to obtain one or more timing measurements. The WTRU may not be able to obtain one or more timing measurements, for example, due to one or more limited WTRU capabilities (e.g., the WTRU is not capable of measuring timing). The WTRU may not receive one or more configurations related to timing synchronization between TRPs, which may prevent the WTRU from calculating an accurate RSTD (Reference Signal Time Difference). Thus, the WTRU may obtain one or more unobservable measurements. Measurements which cannot be measured by the WTRU (e.g., due to limited WTRU capability, unconfigured PRS(s), different time instances, and/or unconfigured TRPs) may be referred to as unobservable measurements and/or unobserved measurements.

Additionally or alternatively, the WTRU may (e.g., only) perform one or more measurements on a PRS transmitted from configured TRPs, and the amount of measurements may be limited to achieve a target accuracy.

Measurements may include one or more anomalies (e.g., sudden non-line of sight (NLOS), one or more unexpected timing errors). The WTRU may detect one or more abnormal measurements to isolate one or more error sources (e.g., timing error) that caused the one or more anomalies.

A WTRU with reduced capabilities (e.g., reduced bandwidth (BW), reduced number of antenna elements) may collect one or more measurements which may not be reliable (e.g., large variation in RSTD and/or RSRP measurements), In that case, for example, the WTRU may enhance the quality of one or more measurements for reduced capability (RedCap) WTRUs to improve accuracy of positioning.

AI/ML-based prediction may be used to determine the estimation and/or inference (e.g., RSTD) based on the one or more actual measurements (e.g., RSRP). The WTRU may receive one or more configurations from the network to determine the estimation. The WTRU may send a request to the network for one or more configurations to enable the function which generates the estimation, for example, based on one or more of the conditions herein (e.g., if at least one condition is satisfied). The input of the function may include one or more measurements made by the WTRU. The WTRU may determine its location, for example, based on (e.g., both) the estimation and/or actual measurement. If the WTRU is configured with WTRU-based positioning, for example, the WTRU may report the determined location to the network, indicating that the estimation is used. If the WTRU is configured with WTRU-assisted positioning, for example, the WTRU may report (e.g., both) estimation and/or one or more measurements to the network.

When the WTRU receives one or more configurations for DL-AoD, the WTRU may measure RSRP of the received PRS. The WTRU may not be required to measure timing information (e.g., time of arrival, RSTD). The WTRU may have a capability to measure timing information. The timing information may improve positioning accuracy by enabling a hybrid positioning method which combines angle-based and timing-based positioning method. Thus, acquisition of unobservable measurements may be a challenge.

An AI/ML model may be trained (e.g., as described herein, with respect to supervised learning, etc.) to predict one or more measurements. The network (e.g., LMF, gNB) may train an AI/ML model (e.g., as described herein, with respect to supervised learning, etc.) based on the one or more measurements reported by the WTRU. The network (e.g., LMF, gNB) may implement the trained AI/ML model to predict the one or more measurements, as described herein. The trained network may be implemented at one or more network entities. The trained model and/or one or more trained model parameters may be sent to another entity based on training (e.g., before being implemented. In examples, the trained AI/ML model may be transferred from the serving gNB to a neighboring gNB. In another example, a trained network may be transferred from gNB to the LMF or vice versa.

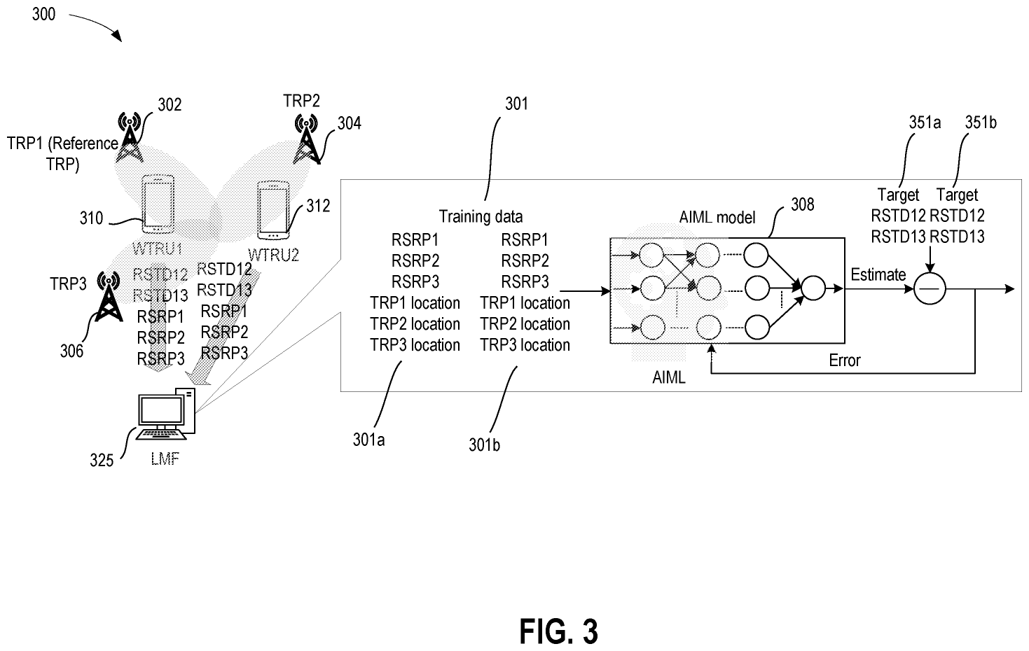

FIG. 3 shows an example of the network training an AI/ML model 300 based on measurements reported by a WTRU (e.g., WTRU1 310 and/or WTRU2 312). In the example shown in FIG. 3, one or more RSRP measurements observed from one or more PRSs transmitted from TRP1 302, TRP2 304, and/or TRP3 306 may be used as inputs for the AI/ML model 308 (e.g., as described herein). As shown in FIG. 3, the network may use one or more TRP locations as part of the training data 301. The training data may include training data 301a and/or training data 301b. The training data 301 may include one or more RSRP measurements and/or TRP locations (e.g., location of TRP1, location of TRP2, location of TRP3, etc.). For example, the WTRU1 may provide inputs 302a (e.g., RSRP1, RSRP2, RSRP3, location of TRP1, location of TRP2, and/or location of TRP3) to train the AI/ML model 308. For example, the WTRU2 may provide inputs 301b (e.g., RSRP1, RSRP2, RSRP3, location of TRP1, location of TRP2, and/or location of TRP3) to train the AI/ML model 308. The training data 301a, 301b may be used to learn/determine one or more parameters and/or tune one or more hyperparameters of the AI/ML model 308, as described herein. The WTRU (e.g., WTRU1 310 and/or WTRU2 312) may receive a respective configuration for PRS (e.g., PRS resources) from the network. Each WTRU may measure RSRP corresponding to PRS1, PRS2, and/or PRS3, which are transmitted from TRP1 302, TRP2 304, and/or TRP3 306, respectively. Corresponding timing information (e.g., RSTD 351a, 351b) may be used as the target. Target output 351a may be a target that is used to train the AI/ML model 308 based on the training data 301a. Target output 351a may include RSTD12 and/or RSTD13 based on one or more training data 301a, for example, provided by WTRU1 310. Target output 351b may include RSTD12 and/or RSTD13 based on one or more training data 301b, for example, provided by WTRU2 312. The training process may be iterated to update the one or more parameters and/or hyperparameters 217 until an end condition is achieved. For example, one or more parameters and/or hyperparameters of the AI/ML model 308 may be iteratively updated until target output 351a, 351b is achieved. The WTRU (e.g., WTRU1 310 and/or WTRU2 312) may measure one or more RSTDs as follows. Firstly, the WTRU (e.g., WTRU1 310 and/or WTRU2 312) may receive a configuration from the network, indicating which TRP and/or PRS is used as the reference. The WTRU (e.g., WTRU1 310 and/or WTRU2 312) may receive an indication from the network that PRS1 is used as the reference. The WTRU may measure time of arrival (ToA) for PRS1 and/or PRS2, namely ToA1 and ToA2, respectively. For example, the ToA for PRS1 may be referred as ToA1, and/or the ToA for PRS2 may be referred as ToA2. For example, the ToA for PRS3 may be referred to as ToA3. The RSTD12 may be calculated by subtracting ToA2 from ToA1 (e.g., RSTD12=ToA1−ToA2). Subsequently, the WTRU (e.g., WTRU1 310 and/or WTRU2 312) may compute RSTD13 by subtracting ToA3 from ToA1 (e.g., with RSTD13=ToA1−ToA3). The WTRU (e.g., WTRU1 310 and/or WTRU2 312) may report RSRP and/or RSTD information to the network, and/or the network may train the AI/ML model 308 with one or more reported measurements. In one or more examples described herein, the term RSRP may be used interchangeably with the terms absolute RSRP and/or relative RSRP, where relative RSRP may be determined based on a reference RSRP.

A WTRU may start using a trained AI/ML model (e.g., 308) based on one or more triggers. In examples, the WTRU may not be capable of measuring RSTD, and/or may measure (e.g., only measure) RSRP for the one or more received PRSs. In such a case, for example, the WTRU may send a request to the network for assistance information to obtain one or more assisting measurements based on one or more of the following conditions (e.g., if one or more of the following conditions is satisfied): the highest RSRP of the received PRS is below a preconfigured threshold; the highest RSRP of the received SSB is below a preconfigured threshold; an average value of RSRP of PRSs for configured TRPs of the received PRS is below a preconfigured threshold; a standard deviation of the WTRU location information obtained from the configured angle-based positioning is above a preconfigured threshold (e.g., for WTRU-based positioning); the WTRU receives a periodic or semi-persistent trigger; and/or the WTRU receives an indication from the network (e.g., LMF, gNB) to determine one or more unobserved measurements from the (e.g., trained) AI/ML model.

The WTRU may send a request to the network for assistance information if the WTRU receives a periodic and/or semi-persistent trigger. For example, the WTRU may be configured with periodic occasions and/or semi-persistent occasions where semi-persistent occasions happen periodically during a time window and/or until the WTRU receives a deactivation command from the network. Semi-persistent occasions may be initiated with an activation command from the network. At one or more (e.g., each) periodic and/or semi-persistent occasions, the WTRU may determine one or more estimated measurements based on actual measurements and/or the WTRU may use the one or more estimated measurements to determine its location.

In examples, the WTRU may receive an indication that the network has an AI/ML model that is trained based on one or more TRPs and/or PRSs which are in line of sight (LOS) with respect to WTRUs from which the network collected measurements. The WTRU may determine to send a request to the network for the configuration of the trained AI/ML model, for example, if the WTRU determines that one or more received PRSs and/or configured TRPs are in LOS with the WTRU. The WTRU may determine whether one or more TRPs and/or PRSs are in LOS based on one or more measurements (e.g., RSRP).

The WTRU may send a request to the network for assistance information (e.g., one or more AI/ML model parameters), for example, based on one or more of the conditions herein (e.g., if one or more of the conditions noted herein is satisfied). The WTRU may receive the information from the network, for example, if the request is granted. Examples of AI/ML model parameters may include one or more weights, one or more (e.g., a number of) layers in a network, an AI/ML model index and/or ID number.

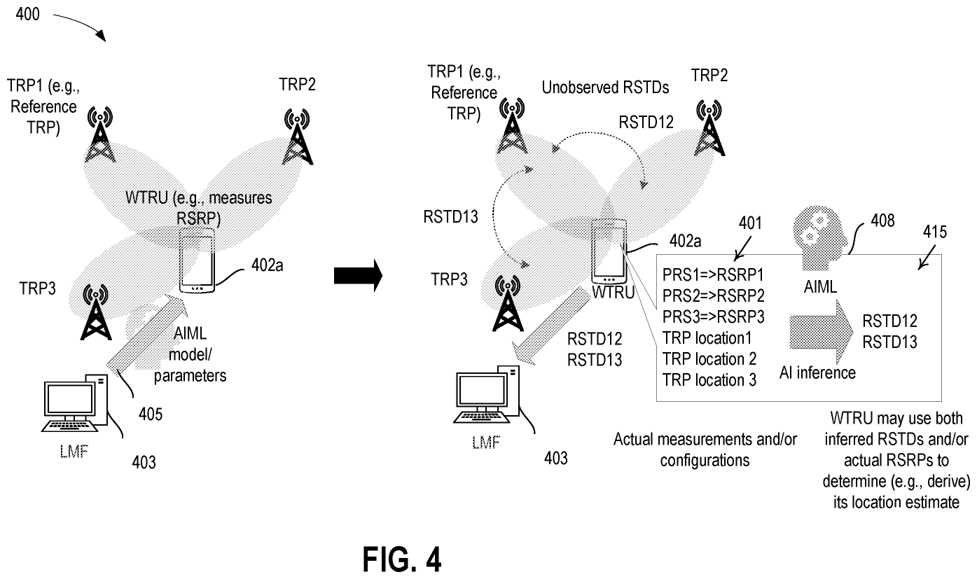

FIG. 4 shows an example system 400 of a WTRU receiving one or more AI/ML parameters 401 from a network entity 403 (e.g., LMF). The WTRU (e.g., 402a) may receive one or more of the following AI/ML parameters 401 from the network 403 as assistance information: one or more weights in an AI/ML model; one or more input attributes for the AI/ML model 408 (e.g., number of TRPs, RSRP for each TRP, location for each TRP, TRP ID, reference TRP ID, PRS ID and/or PRS reference ID used to compute RSTDs and/or differential RSRP where a differential RSRP may be computed by calculating a difference between target RSRP and reference RSRP); one or more output attributes for the AI/ML model 408 (e.g., number of inferred measurements); one or more configurations related to the one or more input attributes (e.g., PRS configurations, reference TRP ID); a type of the output attribute for the AI/ML model 408 (e.g., RSTD, RSRP, etc.); a mapping function where the WTRU (e.g., 402a, 402b) receives information related to parameters and output for the function; and/or a list of one or more AI/ML models 408 (e.g., the WTRU may receive one or more AI/ML models where each AI/ML model corresponds to one or more different characteristics of input measurements (e.g., RSRP)). The WTRU (e.g., 402a, 402b) may receive a configuration indicating how many RSTDs and/or RSRPs the WTRU expects from the AI/ML model 408. The WTRU may determine RSRP from PRS1. The WTRU may perform correlation between the sequence of PRS1, received in the configuration (e.g., provided by the network), and the received signal (e.g., which may include PRS1). The WTRU may perform correlation operation in frequency and/or time domain and/or may determine RSRP, for example, based on the outcome of the correlation operation.

The WTRU (e.g., 402a) may receive a mapping function where the WTRU 402a receives information related to parameters and output for the function from the network as assistance information. Examples of parameters may include RSRP and/or TRP locations, and/or the output of the function may be RSTD. The WTRU (e.g., 402a) may receive one or more parameters related to the function, and one or more examples of these parameters may include one or more coefficients and/or constants for a polynomial.

The WTRU (e.g., 402a) may receive a list of AI/ML models 408 from the network as assistance information. Examples of characteristics of the measurements may include granularities of one or more measurements (e.g., granularity of RSRP values), one or more (e.g., the number of) TRPs corresponding to measurements, and/or a LOS/NLOS indicator associated with one or more measurements. For example, the WTRU (e.g., 402a) may receive one or more (e.g., two) AI/ML models 408, where one AI/ML model generates RSTD measurements based on RSRP measurements made in an LOS environment and/or another AI/ML model generates RSTD measurements 415 based on RSRP measurements 401 made in an NLOS environment. In examples, the WTRU (e.g., 402a) may receive one or more AI/ML models, where the models generate RSTD measurements 415 based on RSRP measurements 401 and one or more (e.g., each) models correspond to one or more different ranges of average RSRP measurements.

Determination of estimated measurements 415, where the estimated measurements 415 are a different type than actual measurements 401, may be performed. In examples, based on the assistance information, the WTRU (e.g., 402a) may determine the one or more estimated measurements 415 (e.g., RSTD) based on the one or more actual measurements 401 (e.g., RSRP) made by the WTRU (e.g., 402a). For example, as shown in FIG. 4, the WTRU 402a may determine one or more RSTDs 415 using the received AI/ML model 408 parameters, RSRP measurements 401 (e.g., RSRP for each PRS received by the WTRU), and/or locations of TRPs from which the WTRU 402a receives PRS. The terms actual measurements and observed measurements may be used interchangeably herein.

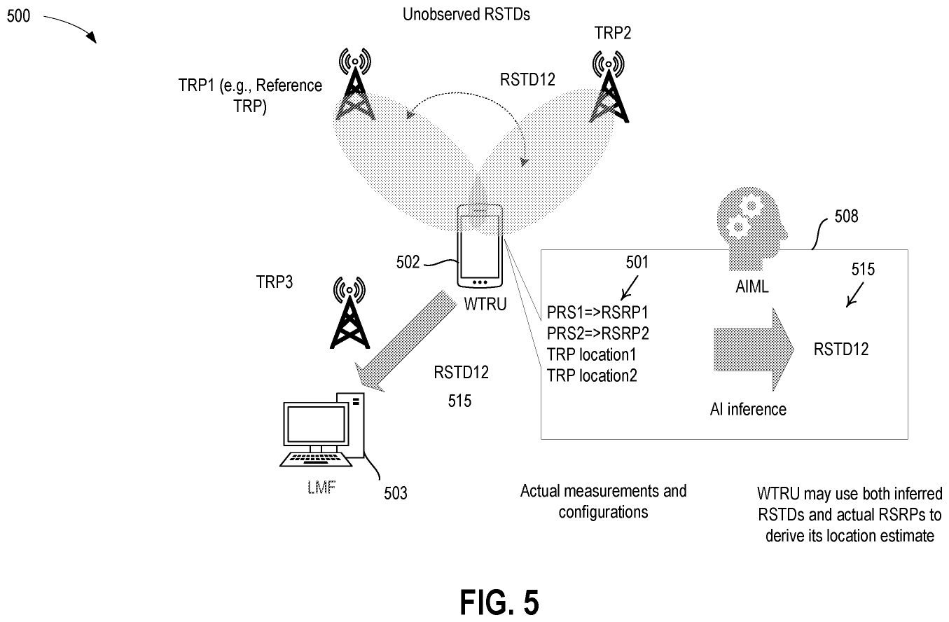

FIG. 5 illustrates an example of inference generation using a system 500. As shown in FIG. 5, the WTRU 502 may determine RSTD12 504 based on input data 501 (e.g., RSRP1 and RSRP2). For example, the WTRU 502 may determine RSTD12 504 based on one or more similar methods as described herein. RSRP1, RSRP2, and/or RSTD12 may be associated with PRS resource IDs.

The one or more measurements (e.g., RSTD) obtained from the AI/ML model and/or one or more other (e.g., configured or prediction) functions may be estimated and/or inferred by the AI/ML model 508 and/or other function(s), for example, based on the one or more input measurements 501 (e.g., RSRP). Examples of the one or more functions may include an interpolation and/or an extrapolation function. The parameters of the function(s) may not be trained, as they may be preconfigured. The one or more other functions may not use AI/ML. In examples, the function may utilize coefficients that are trained for performing the predictions/estimations herein. In examples, the AI/ML model 508 and/or the configured function(s) may be trained at the network 503 (e.g., LMF) such that the model 508 generates one or more inferred measurements 515 (e.g., RSTD12 504). The AI/ML model 508 may include trained parameters and/or tuned hyperparameters to determine the one or more inferred measurements 515 (e.g., RSTD). In examples, the function may generate one or more interpolated and/or extrapolated measurements 515 (e.g., RSTD) based on one or more input measurements (e.g., RSRP and/or RSTD). The terms inferred measurements, output(s), and estimated measurements may be used interchangeably herein.

The WTRU 502 may determine one or more estimated measurements 515 (e.g., unobserved measurements) based on one or more of the following: actual measurements (e.g., RSTD, RSRP); a location of a TRP (e.g., absolute and/or relative position where the relative position may be with respect to the reference TRP); a location of the WTRU (e.g., the WTRU obtains a coarse location of the WTRU based on one or more measurements and/or positioning method such as DL-TDOA, DL-AoD, and/or the like; and/or TRP ID, PRS resource, and/or PRS ID associated with the one or more measurements.

A WTRU may determine which inferred/estimated measurements to use. In examples, the WTRU may use one or more inferred/estimated measurements for one or more Radio Access Technology (RAT) dependent positioning methods (e.g., DL-TDOA, DL-AoD). For example, if the WTRU determines inferred/estimated measurements (e.g., RSTD) based on actual measurements (e.g., RSRP), the WTRU may use the inferred/estimated measurements (e.g., RSTD) for a RAT dependent positioning method (e.g., DL-TDOA). If the WTRU obtains inferred/estimated timing measurements (e.g., RSTD), for example, the WTRU may use the one or more measurements for one or more timing based positioning methods (e.g., DL-TDOA).

If the WTRU cannot obtain the minimum number of measurements required for positioning, for example, the WTRU may determine to use a default positioning method to determine the location of the WTRU and/or report one or more available measurements to the network. For example, if the WTRU cannot obtain the minimum number of inferred/estimated timing measurements for a timing positioning method based on one or more RSRP measurements, the WTRU may determine to use a positioning method that uses RSRP measurements (e.g., DL-AoD). For example, the WTRU may stop using a timing-based method and use a positioning based method, where the positioning based method may be based on RSRP (e.g., only based on RSRP). If the WTRU is configured with a WTRU-based positioning method, for example, the WTRU may determine to use the default positioning method (e.g., DL-AoD) to determine the location of the WTRU. If the WTRU is configured with a WTRU assisted positioning method, for example, the WTRU may determine to report one or more available measurements (e.g., RSRP) to the network.

The terms observed TRPs and unobserved TRPs may include one or more of the following. If the WTRU performs one or more measurements on PRS transmitted from one or more TRPs, for example, the TRPs may be referred to as observed TRPs. If the WTRU does not perform one or more measurements on PRS transmitted from TRPs, for example, the TRPs may be referred to as unobserved TRPs. The WTRU may receive one or more configurations (e.g., configurations related to PRS, TRP location) related to observed and/or unobserved TRPs from the network (e.g., LMF, gNB).

In examples, the WTRU may use both inferred/estimated and actual measurements for RAT dependent positioning methods (e.g., DL-TDOA, DL-AoD). For example, if the WTRU determines one or more inferred/estimated measurements (e.g., RSRP of PRS for unobserved TRPs) based on one or more actual measurements (e.g., RSRP of PRS for observed TRPs), the WTRU may use both actual and inferred/estimated measurements for a RAT dependent positioning method (e.g., DL-AoD).

In examples, the WTRU may use inferred/estimated and actual measurements partially for RAT dependent positioning methods (e.g., DL-TDOA, DL-AoD). For example, the WTRU may determine one or more inferred/estimated measurements (e.g., RSRP of PRS for unobserved TRPs) based on actual measurements (e.g., RSRP of PRS for observed TRPs). If the RAT dependent positioning method accepts N measurements (e.g., RSRP) and the number of actual and inferred/estimated measurements is greater than N, the WTRU may determine one or more measurements to use for positioning, for example, by sorting measurements (e.g., RSRP) in descending order, and/or may choose one or more measurements with N highest RSRP measurements. In examples, the WTRU may determine N measurements (e.g., RSTD, RSRP) based on the one or more LOS indicators associated with the one or more measurements. For example, the WTRU may determine to use RSRP measurements if the LOS indicator is greater than the preconfigured threshold (e.g., use RSRP measurements associated with LOS). In examples, the WTRU may determine N closest TRPs with respect to the estimated WTRU location and/or reference TRP and/or may choose N inferred/estimated RSTDs associated with the one or more chosen (e.g., determined) TRPs.

If the WTRU is configured with WTRU-based positioning, the WTRU may determine its location (e.g., location of the WTRU expressed in global coordinates) based on (e.g., both) one or more actual measurements (e.g., RSRP) and/or one or more estimated measurements (e.g., RSTD). The WTRU may report the determined location information to the network. If the WTRU receives a request from the network, for example, the WTRU may indicate to the network that one or more unobserved measurements are used to determine (e.g., derive) the location information.

If the WTRU is configured with WTRU-assisted positioning, for example, the WTRU may send a measurement report to the network which includes (e.g., both) one or more actual (e.g., RSRP) and/or one or more estimated/inferred (e.g., RSTD estimated by the AI/ML model) measurements. The WTRU may include one or more details related to one or more PRS configurations (e.g., PRS resource ID) in the measurement report.

Inferred/estimated measurements may be used as an expected value. The WTRU may determine to use one or more inferred/estimated measurements as an expected value of one or more measurements. The WTRU may determine one or more inferred/estimated measurements (e.g., RSRP, RSTD) for TRPs that are not part of the configuration. The WTRU may receive an indication from the network (e.g., gNB, LMF) to use the one or more inferred/estimated measurements as the expected value of the measurements.

The WTRU may use the expected value to prepare for one or more PRS measurements. For example, the WTRU may expect to receive PRS within a time window whose duration and/or center are determined (e.g., derived) based on the expected value and/or configured duration.

For example, the RSTD may be defined as RSTD=t1−t0, where t1 and t0 are time of arrival of the target PRS and reference PRS, respectively. Based on the expected value of RSTD (e.g., E_rstd) and the time of arrival of the reference PRS (e.g., t0), for example, the WTRU may determine (e.g., derive) the expected time of arrival for the target PRS as E_rstd+t0. Additionally or alternatively, if the WTRU is configured with an uncertainty value, d, the WTRU may determine a (e.g., time) window that includes a start and/or end time. The window may have a start time expressed as E_rstd+t0−d. For example, the window may have an end time, where the end time may be expressed as E_rstd+t0+d. During the time window, the WTRU may expect to receive the target PRS. Once the WTRU receives the target PRS, the WTRU may record the time of arrival, t1, and/or may determine (e.g., compute) RSTD, t1−t0. The time window may be associated with the PRS resource and/or TRP whose measurements are used to determine (e.g., derive) one or more inferred/estimated measurements, such that the WTRU may use a (e.g., an appropriate) time window to receive PRS.

The WTRU may determine the content of the measurement report depending (e.g., based) on whether the WTRU receives the target PRS during the time window or not. If the WTRU receives the target PRS during the time window, for example, the WTRU may report the actual RSTD. If the WTRU does not receive the target PRS during the time window, for example, the WTRU may report the inferred RSTD.

The WTRU may use the inferred/estimated RSRP to determine the range of RSRP the WTRU uses to receive the PRS. The WTRU may use the range to determine quantization granularity and/or range to receive the PRS.

The WTRU may receive one or more PRS configurations (e.g., reference TRP, PRS resource IDs) from the network (e.g., LMF). The WTRU may receive an indication from the network (e.g., LMF) to determine (e.g., derive) a time window. The WTRU may receive a configuration for the window duration and/or one or more AI/ML models associated with one or more unobserved TRPs. The WTRU may perform one or more measurements on the PRS, and/or may obtain one or more RSRP measurements. The WTRU may obtain one or more measurements (e.g., inferred RSTD from the AI/ML model based on the measurements) for one or more unobserved TRPs. The WTRU may determine (e.g., derive) a time window based on the inferred RSTD and/or an uncertainty value. The WTRU may receive a reference PRS from the unobserved TRP. The WTRU may determine one or more measurements to report. For example, if the WTRU receives the target PRS during the time window, the WTRU may send a measurement report including the actual RSTD and/or one or more RSRP measurements, and/or may indicate that the one or more measurements are actual measurements. If the WTRU does not receive the target PRS during the time window, for example, the WTRU may send a measurement report including inferred RSTD and/or one or more RSRP measurements, and may indicate that the one or more measurements are inferred measurements.

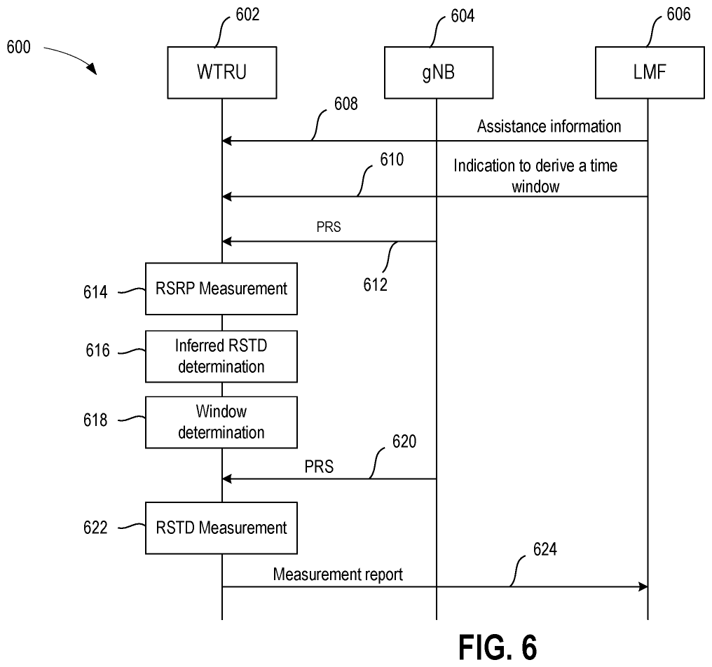

FIG. 6 illustrates an example signal flowchart 600 between a WTRU 602, a gNB 604, and an LMF 606. An AI/ML model can be trained at the network (e.g., LMF and/or gNB) and/or WTRU. The trained AI/ML model may be implemented at (e.g., either, both) the network and/or the WTRU. At 608, the LMF 606 may send assistance information to the WTRU 602. The assistance information may include one or more parameters for characterizing an AI/ML model and/or other function(s). The other function(s) may include a configuration and/or prediction function that may not use AI/ML. In examples, the function may utilize coefficients that are trained for performing the predictions/estimations herein. At 610, the LMF may send an indication to the WTRU 602. The indication 610 may indicate to determine (e.g., derive) a time window. At 612, the gNB 604 may send PRS to the WTRU 602. At 614, the WTRU 602 may measure one or more RSRPs (e.g., as described herein). At 616, the WTRU 602 may determine one or more inferred RSTDs (e.g., as described herein). For example, the WTRU 602 may determine the one or more inferred RSTDs using the AI/ML model or other (e.g., configured) function based on the parameters in the assistance information. At 618, the WTRU 602 may determine a window (e.g., determine a time window as described herein). At 620, the gNB 604 may send PRS to the WTRU 602. At 622, the WTRU 602 may determine one or more RSTD measurements (e.g., as described herein). At 624, the WTRU 602 may send a measurement report (e.g., as described herein).

RSRP may be estimated based on RSTD. For example, the WTRU may determine RSRP based on one or more measured RSTDs. For example, the WTRU may determine RSRP based on one or more measured RSTDs by using a (e.g., trained) AI/ML model. The network may train an AI/ML model which accepts inputs (e.g., RSTDs and/or TRP location information) and/or generates RSRPs corresponding to PRS received from the TRPs. The content of the request for the AI/ML model and/or another (e.g., configuration) function may be based (e.g., depend) on the positioning method configured for the WTRU. For example, if the WTRU is configured with a timing based positioning method (e.g., DL-TDOA), and the maximum and/or minimum standard deviation of measured RSTDs is above the configured threshold, the WTRU may send a request to the network to configure an AI/ML model which generates RSRP based on measured RSTDs. Using measured RSTDs and/or estimated RSRPs, the WTRU may determine its location, for example, if the WTRU is configured with WTRU-based positioning. Additionally or alternatively, if the WTRU is configured with WTRU-assisted positioning, the WTRU may send a report to the network which includes both estimated RSRPs, measured RSTDs and/or corresponding PRS resource IDs.

A WTRU may receive one or more configurations for WTRU-based angle-based positioning method (e.g., DL-AoD with TRP locations) and/or one or more PRS configurations. The WTRU may receive a configuration for the reference TRP, for example, from a network node. The WTRU may receive one or more (e.g., multiple) AI/ML models, where one or more (e.g., each) AI/ML models may be associated with one or more different ranges of the maximum RSRP values. The WTRU may perform one or more measurements on PRS and/or may determine (e.g., obtain) one or more RSRP measurements. If the maximum RSRP value of the measurements is below a threshold, for example, the WTRU may request the AI/ML model based on the range the maximum RSRP value falls into. The WTRU may receive one or more parameters (e.g., weights) for the AI/ML model. The WTRU may determine one or more measurements (e.g., RSTDs from the AI/ML model based on the measured RSRP measurements and/or TRP location information) where the RSTD is based on the reference TRP. The WTRU may determine a location estimate based on the one or more inferred RSTDs, one or more RSRP measurements, and/or TRP information, for example, by using the AI/ML model(s). For example, the WTRU may use both one or more inferred measurements and one or more actual measurements to determine the WTRU location. The WTRU may report the determined location information to the network. In examples, the WTRU may use at least one or more inferred measurements (e.g., in addition to one or more actual measurements) to determine the location of the WTRU using a positioning method (e.g., WTRU based DL-TDOA, WTRU based DL-AoD, etc).

A WTRU and/or network may determine one or more unobservable measurements based on the same type of measurement(s). For example, the WTRU and/or network may determine one or more unobservable measurements based on one or more (e.g., trained) AI/ML model(s) (e.g., as described herein). One or more unobservable measurements may be generated based on the same type of measurements. For example, the WTRU may determine an unobserved portion of measurements based on the same type of one or more actual measurements. The WTRU may determine one or more RSRP measurements from a TRP at the next measurement occasion (e.g., using an AI/ML model, configuration and/or prediction function) based on one or more RSRP measurements up to and including the current measurement occasions. Additionally or alternatively, the WTRU may determine one or more RSRP measurements from a TRP at the next measurement occasion based on the last N measurement occasions where the WTRU receives the value for N from the network (e.g., LMF, gNB). The WTRU may be configured with a range, in terms of measurement occasions, and/or the other function and/or AI/ML model can predict based on the N measurements, and associated TRP(s). Assuming the current time index is indicated as k (e.g., symbol, slot, frame index), the WTRU may be configured with one or more future measurement occasions (Ne) and/or one or more past measurement occasions (Nr). For example, Ne=2 and Nr=3 may indicate that the AI/ML model can predict 2 future measurement occasions (e.g., with time index k+1, k+2) based on the past Nr=3 measurement occasions (e.g., with time index k−3, k−2, k−1).

In examples, the WTRU may receive a configuration for a set of one or more TRPs. The WTRU may determine a measurement for a TRP, which is not included in the configured set, based on one or more actual measurements (e.g., RSTD) from the configured set of TRPs. The WTRU may receive location information of the one or more TRPs (e.g., location information of TRP 1, location information of TRP2, etc.). The WTRU may determine one or more unobserved measurements (e.g., RSTD) for the target TRP, for example, based on one or more of the following measurements and/or information: one or more RSTD measurements and/or associated TRPs; TRP and/or reference TRP location information (e.g., absolute and/or relative location of TRPs where relative location may be determined/derived with respect to the absolute location of the reference TRP); absolute and/or relative locations of one or more target TRP(s), where target TRPs refer to TRPs used to compute RSTD, and/or where at least one of the TRPs used to compute RSTD belongs to the configured set of TRPs; one or more RSRP measurements and/or associated TRPs; PRS resource ID(s) and/or TRP/PRS ID(s) associated with the one or more measurements; and/or the location of the WTRU (e.g., the WTRU may obtain a coarse location of the WTRU based on one or more measurements and/or positioning method (e.g., DL-TDOA, DL-AoD)).

The WTRU may determine unobserved measurements for the target TRP, for example, based on absolute and/or relative locations of target TRP(s), where target TRPs refer to TRPs used to compute RSTD, and where at least one of the TRPs used to compute RSTD belongs to the configured set of TRPs. For example, the WTRU and/or network may determine (e.g., derive) the relative location of the WTRU and/or target or selected TRP with respect to the absolute location of the reference TRP.

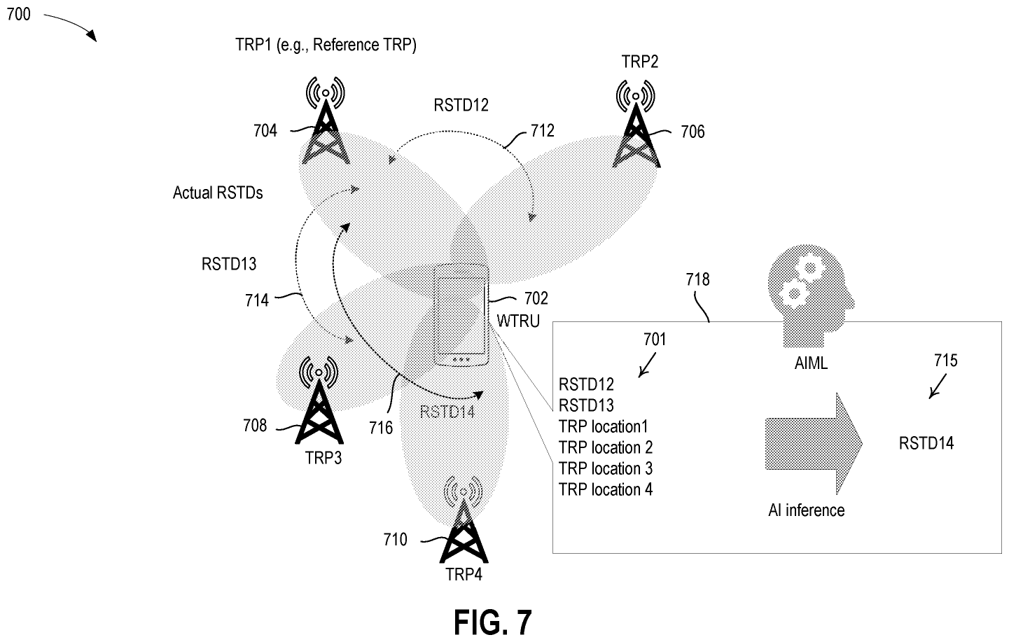

FIG. 7 shows an example system 700 for enabling RSTD prediction based on one or more actual RSTD measurements. As shown in FIG. 7, a WTRU 702 may be configured with one or more (e.g., three) TRPs, TRP1 704, TRP2 706, and/or TRP3 708, where TRP1 704 is used as the reference. The WTRU 702 may receive one or more PRS configurations from the network, may perform one or more timing measurements and/or may determine one or more RSTDs, e.g., RSTD12 711 and/or RSTD13 714. The WTRU 702 may receive information from the network (e.g., via broadcast) about the location of other TRPs (e.g., TRP4 710). For example, the WTRU may receive assistance information that may include one or more parameters for an AI/ML model 718. The WTRU 702 may be configured with an AI/ML model 718 which can generate an RSTD measurement 715 for given input 701. The WTRU 702 may use RSTD12 712 and/or RSTD13 714, location information for TRP1 704, location information for TRP2 706, location information for TRP3 708, and/or location information for TRP4 710, which may be the target TRP. The WTRU 702 may obtain an RSTD value 715 (e.g., RSTD14 716) from the AI/ML model 718, for example, based on the one or more inputs 701. In examples, the WTRU may determine RSTD14 716 based on RSTD12 712, RSTD13 713, and/or TRP location information (e.g., location information of TRP1 704, TRP2 706, TRP3 708, and TRP1 704). The one or more inputs 701 may include one or more RSTD values and/or one or more TRP locations.

AI/ML model 718 may determine (e.g., predict, as described herein) one or more measurements that are valid for a predefined and/or preconfigured area. In examples, the WTRU may determine that one or more predicated measurements by the AI/ML model is valid for preconfigured group of cells. For example, the WTRU may receive one or more configurations of the AI/ML model 718 related to the coverage of prediction. For example, the WTRU may be configured with a coverage where the AI/ML model 718 can determine (e.g., predict) one or more measurements (e.g., radius and/or area within which the target TRP may be located with respect to the reference TRP).

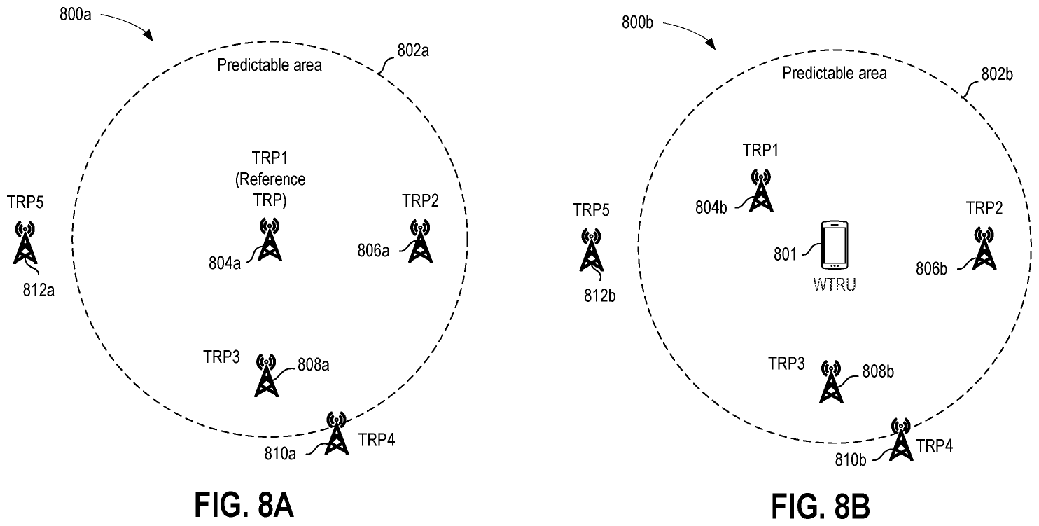

FIG. 8A depicts an example system 800a of a predictable area 802a, where the reference TRP is TRP1 804a. The AI/ML model and/or other function may determine/predict one or more measurements (e.g., RSTD, RSRP) associated with TRP1 804a, TRP2 806a, TRP3 808a, and/or TRP4 810a. The other function may be a configuration or prediction function that may not use AI/ML. In examples, the function may utilize coefficients that are trained for performing the predictions/estimations herein. Since TRP5 812a is outside of the coverage, for example, the one or more measurements associated with TRP5 812a may not be predictable by the AI/ML model.

FIG. 8B illustrates an example system 800b of determining whether TRPs are within the coverage area of prediction/inference 802b, where the center of the coverage is the location of the WTRU 801. In examples, the WTRU 801 may receive a configuration of the AI/ML model related to the coverage of prediction/inference 802b where the coverage is defined based on the WTRU 801 location. Once the WTRU 801 determines its location, for example, the WTRU 801 may send a request to the network for the AI/ML model associated with the WTRU location and/or zone/area in which the WTRU 801 is located. The WTRU 801 may determine the location of the WTRU 801 based on the one or more measurements made on PRS and/or WTRU-based positioning method (e.g., DL-TDOA, DL-AoD). The WTRU 801 may determine whether one or more TRPs are within the coverage area of prediction/inference. An example is illustrated in FIG. 8B, where the center of the coverage is the location of the WTRU 801. One or more measurements (e.g., RSTD, RSRP) associated with TRP1 804b, TRP2 806b, TRP3 808b, and/or TRP4 810b may be predictable by the AI/ML model and/or another function. Since TRP5 812b is outside of the coverage 802b (e.g., predictable area), for example, the one or more measurements associated with TRP5 812b may not be predictable by the AI/ML model (e.g., and/or another function).

The WTRU may determine which zone/area the WTRU is located in based on the estimated WTRU location. The WTRU may receive information related to one or more locations of zones/areas based on which the WTRU determines which zone/area the WTRU is located in. The WTRU may determine that the AI/ML model associated with the zone the WTRU belongs to can predict/infer one or more measurements associated with the one or more TRPs located in the zone.

In examples, if the WTRU does not find one or more (e.g., any) TRPs in the coverage, the WTRU may determine to expand the coverage by a configured expansion factor. If the expanded coverage is below a threshold, for example, the WTRU may determine to use the expanded coverage to search for one or more TRPs. If the expanded coverage is above the threshold, for example, the WTRU may report one or more measurements to the network. In examples, the WTRU may (e.g., continue to) expand the coverage until the WTRU finds N TRPs, where N is an integer configured by the network, and/or until the expiration time for the search.

The WTRU may receive one or more configurations from the LMF PRS configurations including a first group of TRPs and/or a reference TRP. The WTRU may receive assistance information (e.g., one or more parameters for an AI/ML model) and/or associated coverage area (e.g., expressed as a circle), for example, based on the reference TRP, expansion factor, and/or threshold (e.g., diameter of a circle expressed in meters) from the network. The WTRU may receive a second group of TRPs and/or associated location information via broadcast. The WTRU may perform one or more measurements on the PRS received from the first group of TRPs. The WTRU may determine one or more TRPs from the second group of TRPs that fall within the coverage area. For one or more (e.g., each) TRPs in the coverage area, the WTRU may determine a corresponding RSRP (e.g., inference generated from the AI/ML model based on one or more RSRP measurements from the first group). The WTRU may report one or more RSRP measurements and/or corresponding TRP IDs to the network. If the WTRU does not find one or more (e.g., any) TRPs in the coverage area, the WTRU may determine an expanded coverage area based on an expansion factor. If the WTRU does not find one or more (e.g., any) TRPs in the expanded coverage area, the WTRU may compare the expanded coverage area (e.g., the diameter of the expanded coverage area) to a threshold. If the expanded coverage (e.g., the diameter) is below the threshold, the WTRU may again determine the TRPs from the second group of TRPs that fall within the coverage area. If the expanded coverage is above the threshold, the WTRU may report the RSRP from the first group of TRPs to the network. For example, the coverage area may be expressed as a circle (e.g., 802a, 802b). The WTRU (e.g., 801) may compare the size of the coverage area (e.g., diameter of the corresponding circle) to the threshold, and/or may determine whether the WTRU (e.g., 801) can further expand the coverage area (e.g., 802a, 802b). Expansion of the coverage area may be realized by multiplying the diameter by the expansion factor, thus extending the coverage.

Ideal measurement estimation may be performed. For example, one or more ideal measurements may be determined, as described herein.

A WTRU may determine an ideal measurement from an AI/ML model. The WTRU may determine the ideal measurement based on the location of the WTRU and/or the location of one or more TRPs. Additionally or alternatively, the WTRU may determine the ideal measurement (e.g., one or more time measurements) based on a different type of measurement (e.g., power measurement) and/or the AI/ML model. The WTRU may determine the ideal measurement based on one or more of the following. For example, the WTRU may determine an ideal time of arrival (ToA) for the received PRS based on one or more RSRP measurements made on the received PRS and/or the AI/ML model. The WTRU may determine an ideal RSTD for the one or more received PRSs based on one or more RSRP measurements made on the received PRSs and/or the AI/ML model.

As described herein, the ideal RSTD may include the RSTD the WTRU measures without any obstacles and/or elements that create NLOS and/or multipath environment. The terms ideal RSTD and ideal measurements may be used interchangeably herein.

The WTRU may determine an ideal RSTD. For example, the WTRU may determine an ideal RSTD without reflection. For example, the WTRU may determine an ideal RSTD with reflection.

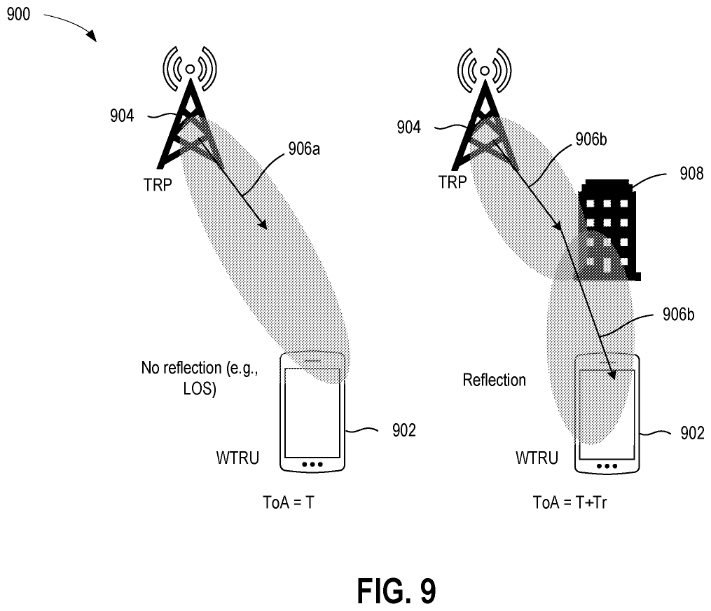

FIG. 9 illustrates an example system 900 showing a time of arrival in the presence of a reflected signal. As shown in FIG. 9, a WTRU 902 may receive PRS (e.g., 906a, 906b) from a TRP 904 For example, the WTRU 902 may receive the PRS 906a directly from the TRP 904, which is in LOS. The time of arrival in the example may be ToA=T (e.g., ideal ToA). For example, the WTRU 902 may receive a PRS 904b which is reflected off an obstacle 908. The time of arrival if the PRS 904b is reflected off an obstacle 908 may be ToA=T+Tr, where Tr may be the additional time it took for PRS 904b to arrive at the WTRU 902 due to reflection. Due to the nature of reflection, for example, there may be one or more uncertainties (e.g., which may be represented as Tr). Thus, the time of arrival in the presence of obstacles and/or NLOS may be unpredictable, and/or may include inaccuracy in the positioning performance.

Based on the WTRU location and/or the TRP location, for example, the ideal ToA may be calculated. For example, if the WTRU determines the distance between the WTRU and TRP based on their respective locations, the WTRU may determine the propagation time by t=d/c, where d represents the distance, (e.g., expressed in meters) between the WTRU and the TRP, and c represents the speed of light (e.g., meters/second). The WTRU may determine the ideal RSTD. For example, the WTRU may determine the ideal RSTD by using the ideal ToA between the WTRU and the target TRP. In examples, the WTRU may determine the ideal ToA (e.g., time of flight, time it took for PRS to reach the WTRU from the TRP) based on the location of the WTRU (e.g., determined based on GNSS/GPS, and/or one or more RAT dependent or independent positioning methods), and/or TRP (e.g., provided in assistance information), and/or speed at which the reference signal travels (e.g., speed of light, c). For example, if the distance between the TRP and the WTRU is expressed as d, ToA may be the distance divided by the speed of light (e.g., d/c) where the speed of light may be represented as 3×10\hat{ }8 meters per second (e.g., c=3e8). The WTRU may determine the ideal RSTD by using the ideal ToA between the WTRU and the reference TRP. For example, the WTRU may determine the ideal RSTD by using the ideal ToA between the WTRU and the target TRP and/or by using the ideal ToA between the WTRU and the reference TRP.

The WTRU may determine an ideal RSTD as follows. For example, under the LOS scenario, if the ToAs from the reference and target TRP are T1 and T2, respectively, the RSTD may be computed as RSTD=T1−T2 (e.g., “ideal RSTD”). If, under the LOS scenario, the ToAs from the reference and target TRP are T1+Tr1 and T2+Tr2, respectively, the RSTD may be computed as RSTD=T1−T2+Tr1−Tr2, which may be the measured/actual RSTD. One or more uncertainties in RSTD may increase in the presence of NLOS.

In examples, the WTRU may train an AI/ML model based on one or more RSRP measurements with an ideal RSTD measurement as the target (e.g., an example of the target during training). The WTRU may obtain the ideal RSTD measurements based on the knowledge of the WTRU location. The WTRU may determine its position based on one or more GNSS/GPS, RAT dependent positioning methods (e.g., DL-TDOA, RTT), and/or configuration from the network where the network has knowledge of the location of the WTRU. The WTRU may determine the ideal RSTD, for example, based on the knowledge of the WTRU location and/or the one or more locations of the TRP(s).

The WTRU may use the AI/ML model to determine the RSTD, for example, once the WTRU obtains the trained AI/ML model and/or one or more parameters thereof. For example, the WTRU may use the AI/ML model to determine the RSTD using one or more methods as described herein. In examples, the WTRU may perform one or more measurements (e.g., RSRP) on the PRS. The WTRU may determine the RSTD from the trained AI/ML model, for example, based on the one or more RSRP measurements. The WTRU may use the determined RSTD(s) with the configured positioning method (e.g., DL-TDOA) to determine the WTRU location. Based on the configuration for the AI/ML model (e.g., input parameters, output parameter), the WTRU may determine to use one or more of the following parameters and/or measurements as an input to the AI/ML model to determine RSTD: one or more measurements (e.g., RSRP/RSRP per path of the PRS resource(s)); a TRP index; and/or the one or more locations of TRPs.

A WTRU may request an AI/ML model and/or one or more parameters thereof trained with one or more ideal measurements. In examples, the WTRU may determine to use the one or more AI/ML models trained with one or more ideal measurements based on one or more of the following criteria: the WTRU determines that the LOS indicator(s) associated with the TRP(s) and/or PRS resource(s) are less than or equal to a preconfigured threshold; the WTRU determines that uncertainty in one or more measurements (e.g., ToA, RSTD) is greater than or equal to the preconfigured threshold; the WTRU determines the presence of one or more (e.g., multiple) paths (e.g., more than one ToA measurement for a PRS resource); the WTRU determines that the RSRP for the PRS resource(s) are less than the preconfigured threshold; and/or the WTRU determines that the number of NLOS TRPs is greater than or equal to the preconfigured threshold. In examples, the WTRU may determine to send a request to the network for an AI/ML model that is trained with ideal measurements as the target based on one or more of the conditions herein (e.g., at least one of the conditions is satisfied).

In examples, the WTRU may determine to send a request to the network for an AI/ML model that is trained with one or more ideal measurements (e.g., ideal RSTD) and/or actual measurements (e.g., actual RSTD) as the target. The WTRU may determine which AI/ML model to request based on one or more of the following conditions: if the WTRU determines that the LOS indicator(s) associated with the TRP(s) and/or PRS resource(s) are less than or equal to a preconfigured threshold, the WTRU may send a request for an AI/ML model trained with one or more ideal measurements; if the WTRU determines that uncertainty in one or more measurements (e.g., ToA, RSTD) is greater than or equal to a preconfigured threshold, the WTRU may send a request for an AI/ML model trained with one or more ideal measurements; if the WTRU determines the presence of one or more (e.g., multiple) paths (e.g., more than one ToA measurements for a PRS resource), the WTRU may send a request for an AI/ML model trained with one or more actual measurements; if the WTRU determines that the RSRP for the PRS resource(s) are less than a preconfigured threshold, the WTRU may send a request for an AI/ML model trained with one or more ideal measurements; and/or if the WTRU determines that the number of NLOS TRPs is greater than or equal to a preconfigured threshold, the WTRU may send a request for an AI/ML model trained with one or more actual measurements.

The terms A/ML model trained with actual measurements and AI/ML model trained with ideal measurements may be used interchangeably herein.

Training AI/ML models with an ideal target at the WTRU may be performed. The WTRU may determine to use the ideal RSTD instead of measurement(s)-based RSTD as the target metric during training, for example, since time of arrival measurements may be affected by multipath channels (e.g., uncertainty in time of arrival may increase in the presence of multipaths).

In examples, the WTRU may train the AI/ML model based on the ideal RSTD and/or measured RSRP. The AI/ML model may be trained to estimate the correct or ideal RSTD, for example, based on one or more RSRP measurements. The one or more RSRP measurements may serve as the fingerprint.

During training, the WTRU may determine to use the one or more ideal measurements (e.g., instead of actual measurements) as the target metric based on one or more of the following criteria: the WTRU received an indication from the network to train AI/ML model(s) with one or more ideal measurements; the WTRU determines that the LOS indicator(s) associated with TRP(s) and/or PRS resource(s) are less than (e.g., below) or equal to a preconfigured threshold; the WTRU determines that uncertainty in one or more measurements (e.g., ToA, RSTD) is greater than or equal to a preconfigured threshold; and/or the WTRU determines the presence of one or more (e.g., multiple) paths (e.g., more than one ToA measurements for a PRS resource).

Trained AI/ML model(s) may be identified. In examples, the WTRU may train one AI/ML model per TRP (e.g., and/or pair of TRPs). Thus, the AI/ML model may be associated with a TRP index (e.g., ID) and/or pair index (e.g., a pair may include two TRPs). The WTRU may determine the AI/ML model index for determination of RSTD, for example, based on the TRP and/or pair of TRPs from which the PRS(s) that the WTRU made one or more measurements are transmitted from.

In examples, the WTRU may train an AI/ML model for a set of TRPs. In this case, the AI/ML model may be associated with a group index. The WTRU may receive, from the network, one or more configurations for TRPs included in a set (e.g., TRP IDs in a set).

In examples, a WTRU may receive one or more configurations for PRS (e.g., PRS resource ID and/or periodicity) and/or a threshold(s) from the network. The WTRU may receive one or more (e.g., more than one) thresholds, where each threshold may be a RSRP threshold and/or may be associated with a group of PRS resources or PRS resource. The WTRU may perform one or more measurements on the PRS from one or more TRPs. The WTRU may be configured with a DL-TDOA positioning method (e.g., the WTRU may determine RSTD). The WTRU may send a request to the network for an AI/ML model trained with one or more ideal RSTD measurements, for example, if the WTRU determines that the RSRP of the PRS resource(s) are less than the threshold. The WTRU may determine one or more ideal RSTD measurements based on the measured RSRP, for example, based on the AI/ML model the WTRU receives from the network. The WTRU may determine its location using the ideal RSTD measurement. The WTRU may report its location to the network.

Differential location reporting may be performed. The WTRU may determine its location information, for example, by using WTRU-based positioning. In examples, when the WTRU is configured with WTRU-based positioning, the WTRU may include differential location information in the report. More than one location information associated with the WTRU may be included in the report if one or more of the following conditions is met: the WTRU is configured with more than one positioning method and the WTRU determines (e.g., derives) its location from one or more (e.g., each) method(s) separately; there are one or more uncertainties in one or more measurements (e.g., multipath channel, reflected PRS) and the WTRU determines (e.g., derives) more than one location; the WTRU obtains one or more unobserved measurements (e.g., inferred/estimated measurements obtained from an AI/ML model) based on which the WTRU can determine (e.g., derive) a (e.g., new) location information; and/or the WTRU receives an indication from a network to report one or more differential locations.

More than one location information associated with the WTRU may be included in the report if the WTRU obtains unobserved measurements (e.g., inferred/estimated measurements obtained from an AI/ML model) based on which the WTRU can derive a new location information. The WTRU may derive a new location information solely based on the unobserved measurements, or on a combination of observed and unobserved measurements.

A differential location may include one or more of the following: given two locations with coordinates, for example, (x1, y1, z1) and (x2, y2, z2), a differential location with respect to the reference point (x1, y1, z1) may be given by (x2−x1, y2−y1, z2−z1). The WTRU may determine the reference location (e.g., based on configuration), and/or the relative location for one or more (e.g., each) location(s) with respect to the reference location, for example, if the WTRU determines more than one location. In examples, the WTRU may determine three locations based on the one or more measurements and/or estimated/inferred location, (x1, y1, z1), (x2, y2, z2) and (x3, y3, z3). In examples, the WTRU may be configured to use (x1, y1, z1) as the reference location since the location is determined (e.g., derived) based on one or more measurements (e.g., only based on one or more measurements). The first and/or second differential locations may be determined as p21=(x2−x1,y2−y1,z2−z1) and p31=(x3−x1,y3−y1,z3−z1), respectively. The locations (x2, y2, z2) and (x3, y3, z3) may be estimated locations for which the WTRU may use a differential location with respect to a reference point and/or location.

The WTRU may determine and/or derive the reference location based on one or more of the following criteria: one or more actual measurements; an indication from the network (e.g., the WTRU is indicated to use the reference location derived from the AI/ML model, the WTRU is indicated to use the reference location derived using WTRU-based positioning method such as DL-TDOA, DL-AoD); a configured default positioning method; the first location estimation determined/derived by the WTRU; one or more measurements on PRS transmitted from the reference TRP; and/or the WTRU is indicated to use the location information derived at indicated time (e.g., N slots/frames/subframes/seconds prior to the current slot, at time T where T may be indicated by absolute time, slot/frame/subframe ID, etc.).

The WTRU may receive one or more configurations from the network (e.g, LMF) for WTRU-based angle-based positioning method (e.g., DL-AoD with TRP locations) and/or one or more PRS configurations including a first group of TRPs and/or a reference TRP. The WTRU may receive an indication from the network to use the determined (e.g., derived) location as the reference location. The WTRU may receive a second group of TRPs and/or associated location information via broadcast. The WTRU may determine a first set of one or more measurements (e.g., RSRP) on PRS received from the first group of TRPs. The WTRU may determine the first location information, for example, based on the first set of measurements using the configured WTRU-based positioning method. The WTRU may send a request to the network for an AI/ML model associated with the first location. The WTRU may receive assistance information (e.g., one or more parameters for an AI/ML model) and/or associated coverage area from the network. The WTRU may determine one or more TRPs from the second group of TRPs that fall within the coverage. For one or more (e.g., all) TRP(s) in the coverage, the WTRU may determine the second set of measurements (e.g., one or more inferred RSRP measurements for each TRP obtained from the AI/ML model) based on the first set of RSRP measurements. The WTRU may determine the second location information based on the first and/or second set of measurements, for example, by using the configured positioning method. The WTRU may report the first location information as the reference location and/or relative location information between the first and second location information.

AI/ML-based prediction for WTRUs with one or more reduced capabilities may be performed, as described herein. The WTRU may determine the estimated/inferred measurement (e.g, RSTD) based on one or more actual measurements (e.g., RSRP). The WTRU may receive configurations from the network to determine the one or more estimated measurements. The WTRU may send a request to the network for one or more configurations to enable the function which generates one or more estimated measurements, for example, if one or more conditions are satisfied. The input of the function to generate one or more estimated measurements may include the one or more actual measurements made by the WTRU. The WTRU may determine its location based on (e.g., both) one or more actual measurements and/or one or more estimated measurements. The WTRU may report the determined location to the network, for example, if the WTRU is configured with WTRU-based positioning; the report may indicate that the one or more unobserved measurements are used. The WTRU may report both actual and estimated measurements to the network, for example, if the WTRU is configured with WTRU-assisted positioning.

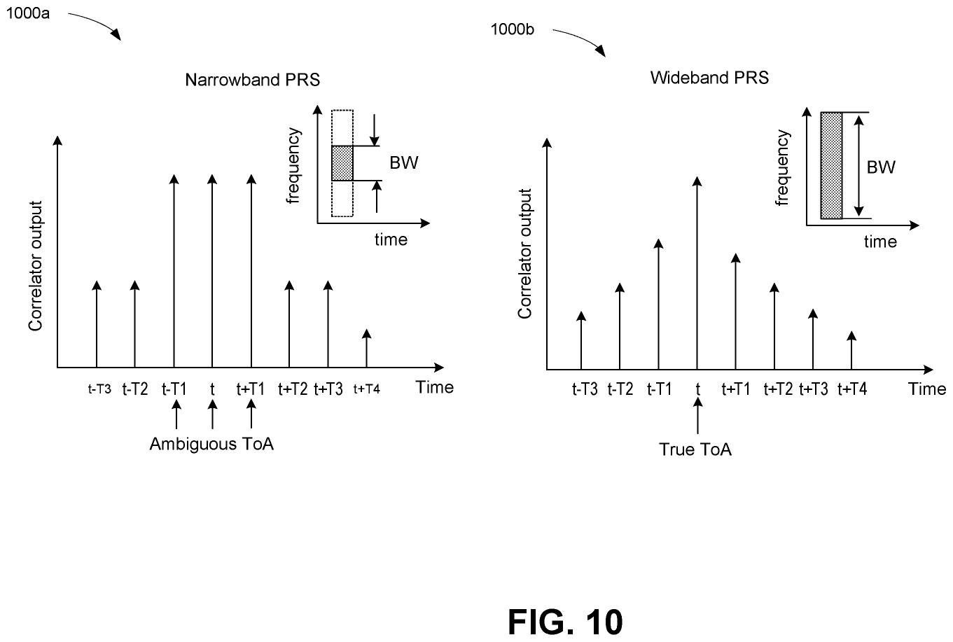

FIG. 10 shows an example graphs 1000a, 1000b of the estimate for time of arrival using a narrowband PRS and a wideband PRS. For example, FIG. 10 depicts a comparison of one or more correlator outputs for narrow and wideband orthogonal frequency-division multiplexing (OFDM) to illustrate that enhanced resolution with narrowband measurements may be included. As illustrated in graph 1000a of FIG. 10, using the one or more measurements obtained from PRS over a relatively small (e.g., reduced) bandwidth, for example due to coarse resolution in the time domain, may include determination of time of arrival that becomes uncertain. An example of a relatively smaller bandwidth may be 2.5 MHz, 5 MHz, 20 MHz, etc. Another or relatively larger bandwidth may be 100 MHz, 200 MHz, 1 GHz, for example. As opposed to the one or more measurements obtained with the narrow bandwidth, for example due to its fine time resolution, one or more measurements obtained from increased bandwidth of PRS may provide more accurate estimate of time of arrival. The graph 1000b in FIG. 10 depicts an illustration of the estimate for time of arrival using a relatively large bandwidth.

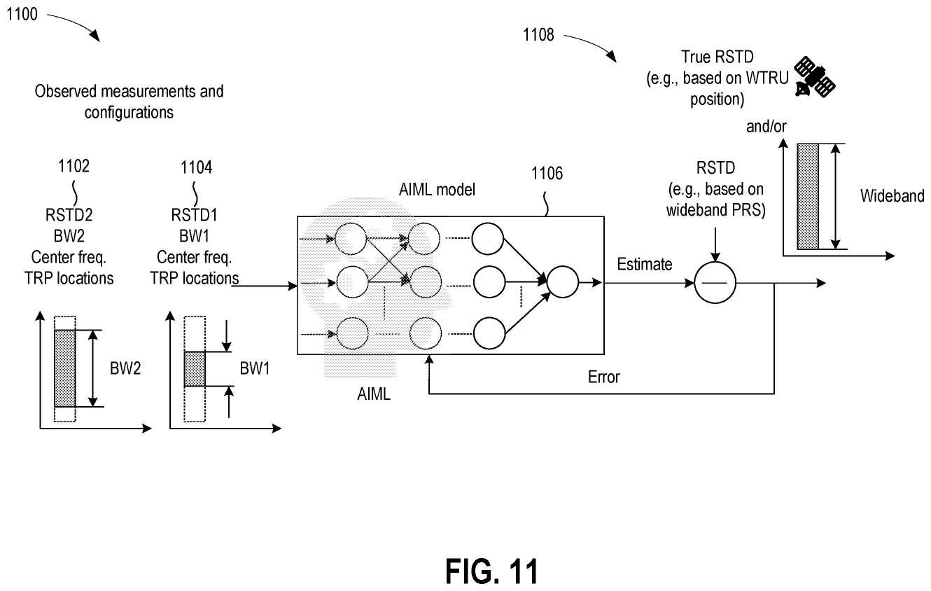

An AI/ML model may be trained. FIG. 11 depicts an example system 1100 for of training an AI/ML model to generate inference 1100. The AI/ML model may use one or more measurements, obtained from one or more (e.g., various) bandwidths, as inputs for the AI/ML model. The target value of the AI/ML model may include one or more measurements obtained from one or more large bandwidths. For example, one or more measurements obtained from one or more large bandwidths may be used as the target value of the AI/ML model.

As shown in FIG. 11, one or more RSTD measurements (e.g., RSTD2 1102 and/or RSTD1 1104) may be presented as input(s) for the AI/ML model 1106. The one or more RSTD measurements (e.g., RSTD1 1104 and/or RSTD2 1102) may be reported by the one or more WTRUs, which may have different bandwidths (BW). For example, RSTD1 1104 may be associated with BW1 and/or RSTD2 1102 may be associated with BW2. The one or more RSTD measurements may be associated with one or more different TRPs where the association information is included in the measurement report. The network may train the AI/ML model 1106 where the target (output 215) may be RSTD values determined (e.g., derived) from the one or more WTRU locations obtained from GNSS, for example, based on the one or more measurements. For example, the RSTD values may be determined based on a trained AI/ML model 1106 (e.g., as described herein). Additionally or alternatively, one or more outputs 1108 may include one or more RSTD measurements obtained using a relatively wider bandwidth may be used as the target value. For example, the target value(s) may include RSTD determined based on WTRU position, TRP location, and/or RSTD based on (e.g., wideband) PRS. The network may compute a difference between the target RSTD and estimated RSTD and/or may compute one or more parameters for the AI/ML model 1106 (e.g., to train the one or more parameters and/or tune the one or more hyperparameters 217). An AI/ML model may be used in implementation (e.g., after training). The trained AI/ML model may receive input data to determine one or more outputs; the one or more output may be used as one or more inferences.

The one or more inputs to the AI/ML model 1106 during training may include one or more measurements (e.g., RSTD, RSRP) from one or more neighboring and/or adjacent bands and/or adjacent bandwidth parts (BWPs).

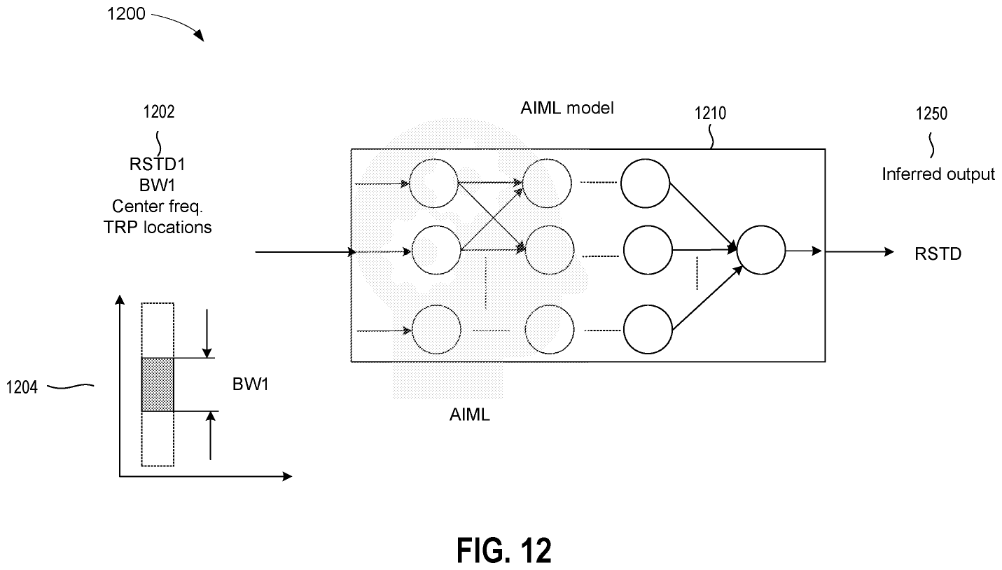

FIG. 12 shows an example system 1200 illustrating inference generation from a trained model (e.g., AI/ML model 1210). As shown in FIG. 12, the WTRU may obtain the estimated RSTD (e.g., RSTD1 of the input 1202) based on the measurements obtained from reduced bandwidth (e.g., 1204). For example, the trained A/ML model may use the trained parameters and/or tuned hyperparameters to predict one or more outputs (e.g., inferred output 1250), as described herein.

The WTRU may receive one or more configurations for the one or more inputs to the AI/ML model. The one or more configurations may be included as one or more inputs 207 for the AI/ML model 1210, as described herein. For example, the WTRU may determine the one or more estimated measurements based on one or more of the following configurations and/or measurements (e.g., inputs 1202): RSTD measurement; bandwidth; center frequency; location of TRP from which PRS is transmitted; frequency layer ID; PRS ID; PRS resource ID; and/or reference information which is used to compute RSTD and/or differential RSRP (e.g., reference PRS resource ID, reference PRS ID, reference TRP ID, etc.).

One or more conditions may trigger AI/ML based measurement estimation. The WTRU may send a request to the network for an AI/ML to generate one or more estimated measurements, for example, based on one or more of the following conditions: the WTRU has reduced capability (e.g., reduced bandwidth, reduced number of antennas, etc.) compared to non-reduced capability; the maximum RSRP of the PRS is below a threshold; the average PRS of the PRS is below a threshold; standard deviation and/or variance of PRS is below a threshold; and/or one or more TRPs from PRS that are transmitted are in LOS (Line of Sight) and/or the soft LOS indicator(s) (e.g., a value indicating the likelihood of LOS between the TRP and the WTRU) for the TRP(s) is above a threshold.

The WTRU may receive one or more PRS configurations from the network and/or may perform one or more measurements on PRS. If the average RSRP of the measured PRS is below the threshold, the WTRU may send a request to the network for configurations for the AI/ML model. Based on the AI/ML model, the WTRU may determine estimated RSTD. The WTRU may determine its position using estimated RSTD.

The WTRU may receive one or more PRS configurations (e.g., BW, center frequency, TRP locations). For example, the WTRU may receive one or more PRS configurations from the network. The WTRU may perform one or more measurements on PRS. The WTRU may request the AI/ML model, for example, if the average RSRP of the PRS is below the threshold. For example, the WTRU may send a request to the network for one or more configurations for the AI/ML model. The WTRU may receive the AI/ML model from the network. For example, the WTRU may determine estimated RSTD from the AI/ML model based on one or more measured RSTD and/or one or more PRS configurations. The WTRU may determine its position based on the (e.g., estimated) RSTD.

AI/ML-based anomaly detection may be performed. WTRU behavior associated anomaly detection may be provided herein. For example, one or more methods for a WTRU to determine/detect anomaly associated with one or more measurements and/or one or more (e.g., various) triggers for anomaly detection may be provided herein.

The WTRU may determine an estimated measurement (e.g., RSTD) based on a first measurement (e.g., RSRP). The WTRU may determine a difference (e.g., absolute value of a difference between two values) between the estimated measurement and a second measurement (e.g., RSTD) or actual measurement. The WTRU may determine to send a request to the network to change the PRS configuration, for example, if the difference (e.g., between the estimated measurement and a second measurement) is above the preconfigured threshold.

The WTRU may determine one or more anomaly(ies). For example, the WTRU may determine one or more anomaly(ies) using an AI/ML model (e.g., specifically) configured for anomaly detection. One or more (e.g., various) details about model input, output, and/or one or more model training aspects and/or WTRU reporting aspects may be provided herein.

One or more (e.g., various) triggers, criteria for detection, and/or WTRU behavior may be included (e.g., common) across one or more (e.g., multiple) examples (e.g., embodiments) provided herein.

In communication, one or more unexpected errors in one or more measurements may occur. One or more errors may be based on one or more different aspects (e.g., error sources). For example, one or more changes in the environment may cause one or more changes to the one or more measurements. One or more changes to the measurements may (e.g., subsequently) alter one or more (e.g., various) downstream quantities that are either derived and/or determined based on the one or more measurements. For example, a sudden presence of an obstacle (e.g., moving vehicle and/or pedestrian, one or more fallen objects) between the transmitter may contribute to lowered RSRP and/or one or more (e.g., multiple) measurements of time of arrival due to multipath. The transmitter and/or receiver may change its transmission and/or reception hardware during communication, which may introduce unexpected timing error in one or more timing based measurements. The WTRU may detect the anomaly and/or inform the network about the anomaly, for example, if an anomaly (e.g., unexpected error) is detected in one or more measurements.

An anomaly may be detected based on a difference between one or more estimated and actual measurements. Generation of estimation and/or inference of one or more measurements may be performed as provided herein.

The WTRU may determine the difference between one or more actual measurements and estimated measurements, for example, based on the one or more estimated measurements the WTRU obtains. For example, the WTRU may determine the difference between one or more actual measurements and estimated measurements after the WTRU obtains one or more estimated measurements. The WTRU may determine the presence of an anomaly in one or more measurements (e.g., and/or error source), for example, if the difference is above the threshold. The difference may include an absolute value of a difference between one or more (e.g., two) values and/or squared value of the absolute difference.

The WTRU may use a threshold to determine one or more anomaly(ies) in the one or more measurements. The threshold used by the WTRU to determine whether there is an anomaly in the one or more measurements may be based on (e.g., depend on) the type of the measurement. For example, the WTRU may receive one or more different thresholds for timing-based and/or RSRP-based measurements and/or may use one or more separate thresholds based on (e.g., depending on) whether the error is computed using one or more timing and/or RSRP based measurements. For example, the WTRU may use a (e.g., first) threshold for one or more timing-based measurements. For example, the WTRU may use a (e.g., second) threshold for RSRP-based measurements.

Since one or more actual measurements and/or estimated measurements may include noise, the WTRU may determine to compute the average of the estimated measurements and/or actual measurements, for example, if the WTRU receives configuration from the network. Averaging of the one or more actual and/or estimated measurements may be performed over the error between estimated measurement and actual measurement. For example, the WTRU may be configured by the network, the number of measurement occasions, N, over which the WTRU may be expected to compute average. For example, the error δ may be an average of the one or more measurements collected over N occasions where the measurement and/or estimated measurement at the ith occasion are denoted as yᵢ and ŷᵢ, respectively:

$$δ = \frac{1}{N} {\sum }_{i = 1}^{N} {y}_{i} - {\hat{y}}_{i}$$

Additionally or alternatively, the WTRU may compute an average of absolute error as follows:

$$δ = \frac{1}{N} {\sum }_{i = 1}^{N} \vert {y}_{i} - {\hat{y}}_{i} \vert$$

Additionally or alternatively, the WTRU may compute a root mean square of the error as follows:

$$δ = \sqrt{{{\sum }_{i = 1}^{N}}^{\frac{\vert {y}_{i} - {\hat{y}}_{i} {\vert}^{2}}{N}}}$$

Anomaly detection may be performed based on an AI/ML model specifically configured for anomaly detection. In examples, a WTRU may be configured with a AI/ML model for the purpose of anomaly detection, which may be referred to as Anomaly detector AI/ML model. The WTRU may obtain the AI/ML model and/or one or more configuration parameters thereof from the network. Such AI/ML models may be pretrained. For example, the one or more AI/ML models may be pretrained specifically for the geographical area where the WTRU is located. The AI/ML model for anomaly detection may be based on WTRU implementation. In examples, the WTRU may be configured to train and/or finetune the AI/ML model. For example, the WTRU may be configured to train and/or finetune the AI/ML model based on one or more WTRU measurements and/or assistance data from the network. For example, the WTRU may receive assistance data including one or more training labels for training the anomaly detector model. For example, based on one or more WTRU reports, the network may determine the presence of anomaly. The WTRU may receive an indication from the network about the anomaly and/or such indication may be associated with a previous WTRU report. The WTRU may (e.g., then) use the indication as a training label and/or the previous report as input to train the AI/ML model. The WTRU may receive a training data set including a plurality of input data and/or one or more corresponding output/training label pairs. The WTRU may request the network for training data. For example, the WTRU may request the network for training data that includes information about the input to the AI/ML model, size of training data, output of the AI/ML model, and/or the like. The WTRU may be configured to report the status of training associated with the anomaly detector AI/ML model. For example, the WTRU may be configured implicitly and/or explicitly to start anomaly detection. For example, the WTRU may be configured to start anomaly detection based on the training status of the AI/ML model. For example, the WTRU may report that the AI/ML model is trained successfully and/or (e.g., subsequently) receive an activation command from the network to start anomaly monitoring. Additionally or alternatively, the WTRU may be configured by the network with a criteriafor training completion (e.g., when the AI/ML model successfully detects anomaly given a preconfigured training data set). The WTRU may be configured to autonomously activate anomaly detection when the training criteria is satisfied.

The AI/ML model for model for anomaly detection may be a classifier model (e.g., may perform the task of binary classification). For example, the inference output of the AI/ML model may indicate whether an anomaly is detected or not, given the set of one or more inputs described herein.

In examples, the AI/ML model for model for anomaly detection may include a regression model, where the inference output of the AI/ML model may indicate the probability of an anomaly being detected, given the set of one or more inputs described herein.

In examples, the AI/ML model may perform that task of prediction, where the inference output of the AI/ML model may indicate the probability of an anomaly being detected at a future time instance (e.g., t+n), given the set of one or more inputs, at time t described herein. For example, t can be the current slot (e.g., or frame, subframe) index and/or n can be the number of slots (e.g., or frames, subframes) at which the anomaly may take place.

An AI/ML model for anomaly detection may include one or more observed measurements as input. The terms observed measurements and actual measurements may be used interchangeably herein. Such observed measurements may include one or more of the following: one or more (e.g., number of) TRPs; RSRP for one or more (e.g., each) TRP; one or more SSB/CSI-RS measurements; Channel Impulse Response (CIR); Channel Frequency Response (CFR); one or more doppler measurements; and/or the like. Additionally or alternatively, the AI/ML model input may include one or more parameters that are based on configuration and/or value (e.g., one or more measurements such as time of flight, ToA RSTD, RSRP) determined based on measurements including but not limited to: one or more TRP identities, RSRP for one or more (e.g., each) TRP, location of TRP, reference TRP ID, PRS ID, PRS resource ID, reference PRS ID, one or more RSTD values, differential RSTD, frequency layer ID, bandwidth configuration, etc. In examples, the AI/ML model may take as an input one or more historical measurement quantities. For example, one or more historical measurement quantities may include one or more of: RSRP, CIR, CFR, and/or the like. from previous time instances. In recurrent AI/ML model architectures, for example, the AI/ML model output from time t−n may be provided as input to the AI/ML at time t. The WTRU may be configured to pre-process one or more inputs to the AI/ML model, including but not limited to one or more (e.g., various) transformations applied to input (e.g., scaling, sampling, filtering outliers, etc.).

WTRU reporting may be performed, as described herein. The WTRU may be configured to transmit an indication to the network, for example, if the AI/ML model determines that an anomaly is detected. In examples, the criteria for anomaly detection may be based on instantaneous output of AI/ML model. For example, the WTRU may be configured to transmit a report of the anomaly if the AI/ML model determines the probability of anomaly is above a preconfigured threshold. The criteria for anomaly detection may be based on post processing the output of AI/ML model for a preconfigured time period. For example, post processing may include determining one or more statistics of AI/ML model output if one or more (e.g., the number of) anomalies detected within a time period is above a threshold.

The AI/ML model may produce one or more additional outputs that characterizes the source of anomaly. For example, the AI/ML model, in addition to indicating that an anomaly is detected, may further indicate the source of anomaly. One or more (e.g., each) source(s) of the anomaly may be abstracted as a specific cause value. The WTRU may be configured to the report the error source (e.g., and/or equivalently a specific cause value) if the AI/ML model determines that an anomaly is detected and/or if the probability of anomaly is above a preconfigured threshold.

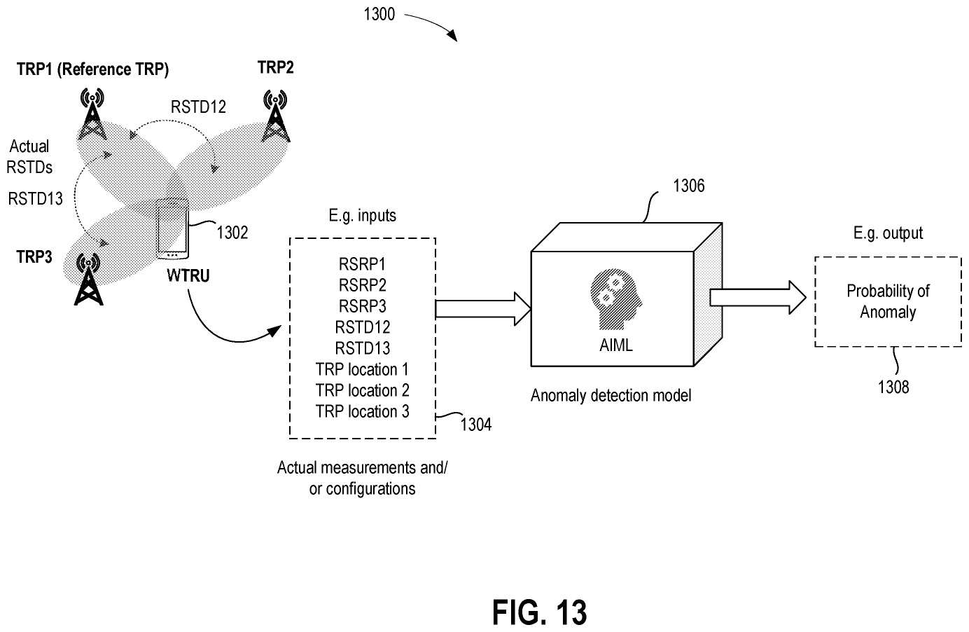

FIG. 13 illustrates an example system 1300 for anomaly detection. As shown in FIG. 13, the WTRU 1302 may apply a AI/ML model 1306 for detecting one or more anomaly(ies). The WTRU 1302 may receive a trained AI/ML 1306 and/or one or more parameters thereof from the network and/or apply a WTRU implementation based AI/ML model 1306. The AI/ML model 1306 may determine (e.g., produce) as an output 1308 the probability of anomaly being detected, for example, based on one or more inputs 1304 (e.g., one or more actual RSRP measurements, one or more RSTD measurements and/or TRP location information, and/or the like) For example, the anomaly detection model 1306 may use an AI/ML model and one or more inputs 1304 (e.g., RSRP1, RSRP2, RSRP3, RSTD12, RSTD13, TRP location 1, TRP location 2, TRP location 3, etc.) to determine one or more outputs 1308 (e.g., probability of anomaly). The WTRU may be configured to transmit a report to the network, for example, based on post processing the output 1308 of AI/ML model 1306.

One or more examples described herein may be applied to (e.g., both) the first and/or the second example procedures for anomaly detection.

The WTRU may be configured with a time window during which the WTRU monitors the error between one or more actual measurements and one or more estimated measurements. Examples of details of configuration of a time window may include the start and/or end time of the window and/or duration of the window, expressed in number of symbols, slots, frames, and/or absolute time (e.g., seconds). The WTRU may stop anomaly detection, for example, once the time window expires. During the window, the WTRU may (e.g., continue to) monitor the error even after the WTRU detects and/or reports the anomaly to the network.

The WTRU may be configured with one or more (e.g., the number of) iterations the WTRU is expected to perform anomaly detection. For example, the WTRU may be configured with an integer M by the network and/or the WTRU may be expected to repeat the anomaly detection procedure for M iterations. The WTRU may include how many occasions the error is greater than the threshold in the measurement report. Additionally or alternatively, the WTRU may terminate the procedure (e.g., iteration), for example, once the error is found. Once the error is found, the WTRU may perform anomaly reporting (e.g., send a report to the network to indicate that anomaly is found) and/or send a request to the network for reconfiguration of PRS.

Anomaly detection may be triggered. For example, one or more conditions may trigger anomaly detection. The WTRU may initiate anomaly detection based on one or more of the following: an indication from the network to initiate anomaly detection; availability of reference/actual/expected measurements (e.g., when the WTRU receives one or more expected RSTD measurements from the network); a training status of anomaly detector AI/ML model (e.g., the WTRU may start anomaly detection when the anomaly detector AI/ML model is successfully trained); variance and/or standard deviation is larger than a preconfigured threshold; RSRP of the measured PRS resource is smaller than a preconfigured threshold; a change in timing error group (TEG) in PRS since the last occasion the WTRU received a configuration for TEG; an NLOS indicator (e.g., soft indicator indicating whether the channel is NLOS or not) is greater than a preconfigured threshold; and/or a periodic or semi-persistent trigger.

The WTRU may initiate anomaly detection based on an NLOS indicator. For example, 0.5 may indicate the channel may or may not be NLOS, while values of 0 and 1 may indicate the channel is LOS or NLOS, respectively.

The WTRU may initiate anomaly detection based on a periodic or semi-persistent trigger. For example, the WTRU may be configured with one or more periodic occasions and/or semi-persistent occasions where semi-persistent occasions happen periodically during a time window or until the WTRU receives a deactivation command from the network. One or more semi-persistent occasions may be initiated with an activation command from the network. The WTRU may perform anomaly detection by computing the error and/or comparing the error against the threshold, for example, at one or more (e.g., each) periodic and/or semi-persistent occasion.

The WTRU may initiate the anomaly detection procedure, for example, based on one or more of the conditions herein (e.g., if one or more of the conditions herein is satisfied). The WTRU may initiate anomaly detection by starting the time window based on one or more pre-configured parameters related to the time window. The WTRU may send a request to the network to send the one or more configurations to the WTRU, for example, if the WTRU does not have one or more configurations for the time window. The WTRU may initiate the time window, and/or (e.g., equivalently) anomaly detection, at a preconfigured timing offset from an occasion. The occasion may be the timing the WTRU determines that the condition to initiate anomaly detection is satisfied. The WTRU may send a request to the network for configuration of AI/ML models, for example, if the WTRU is not configured with an AI/ML model to estimate one or more measurements.

The WTRU may determine to perform one or more actions based on a determination that one or more errors are above a preconfigured threshold. For example, the WTRU may determine to perform one or more of the following actions after the WTRU determines that one or more errors is/are above a preconfigured threshold: reconfiguration of one or more PRS parameters; notifying the network that an anomaly is detected, and/or measurement reporting.

The WTRU may perform reconfiguration of one or more PRS parameters, for example, based on whether the WTRU determines that the error(s) is/are above the preconfigured threshold(s). For example, the WTRU may perform reconfiguration of one or more PRS parameters after the WTRU determines that an error is above a preconfigured threshold. The WTRU may send a request for reconfiguration of one or more PRS parameters. The WTRU may determine to reconfigure one or more different PRS parameters based on (e.g., depending on) the error and/or associated measurement. For example, the WTRU may determine to send a request to the network to change TEG associated with the PRS resource, such that the potential error source can be avoided, if the error related to one or more timing measurements (e.g., RSTD) for the measured PRS resource is greater than a threshold. In examples, the WTRU may be preconfigured with a list of one or more TEGs for one or more PRS resources.

The WTRU may determine to send a request to the network to change transmission source (e.g., TRP) by specifying associated PRS ID, TRP ID, and/or PRS resource ID, for example, if the error is related to one or more power (e.g., RSRP) measurements and/or one or more timing measurements is greater than the threshold. In examples, the WTRU may receive one or more pre-configurations from the network including a list of TRP IDs, PRS IDs, and/or PRS resource IDs from which the WTRU determines to make a request.

The WTRU may notify the network (e.g., send a report to the network indicating detection of anomaly) that one or more anomaly(ies) is/are detected, for example, based on whether the WTRU determines that the error(s) is/are above the preconfigured threshold(s). For example, the WTRU may notify the network that one or more anomaly(ies) is/are detected after the WTRU determines that the error(s) is/are above the preconfigured threshold(s). The WTRU may send an indication to the network that the anomaly is detected. The WTRU may send a report indicating an error source which caused the anomaly. For example, the WTRU may indicate to the network that a timing-based error source (e.g., timing offset, calibration error, clock drift, and/or inter-TRP synchronization error) is present in one or more measurements based on the difference computed using one or more timing-based measurements. For example, the WTRU may indicate that multipath and/or NLOS related error source is present in one or more measurements based on the difference computed using one or more power-based measurements. For example, the WTRU may indicate the presence of one or more transmitter side error sources (e.g., TRP location, antenna offset, etc.).

The WTRU may perform measurement reporting based on whether a determination that one or more errors is/are above a preconfigured threshold. For example, the WTRU may perform measurement reporting after the WTRU determines that the error(s) is/are above the preconfigured threshold. The WTRU may report both actual measurements and associated error to the network, for example, if the error is greater than the preconfigured threshold. The WTRU may include a timestamp associated with the one or more actual measurements.

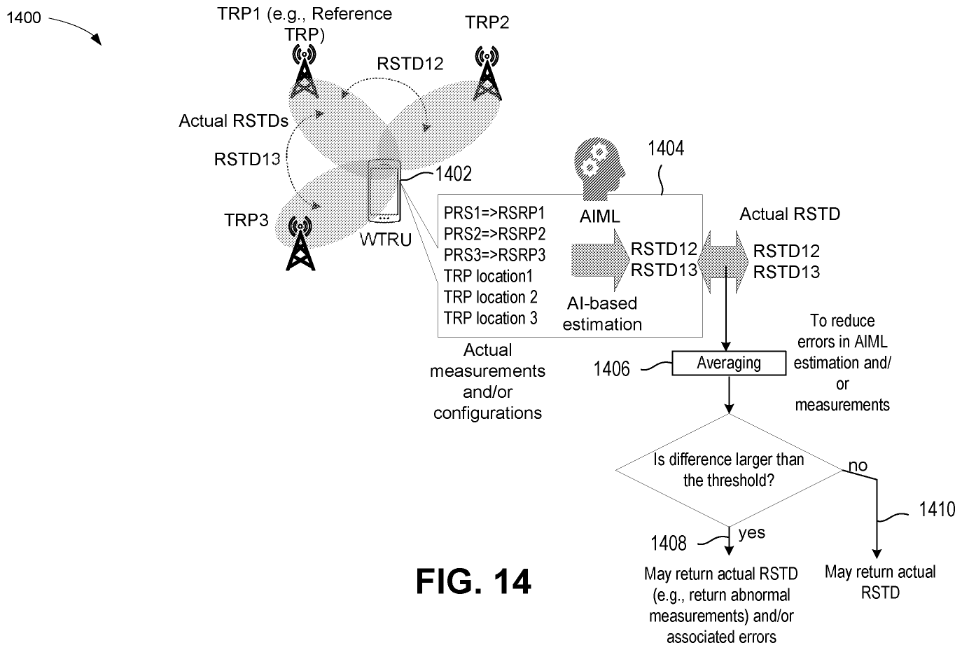

FIG. 14 illustrates an example process 1400 of use of AI for anomaly detection. As shown in FIG. 14, the WTRU 1402 may receive a trained AI/ML 1404 and/or one or more parameters thereof from the network. The WTRU 1402 may obtain one or more estimated RSTD measurements from the AI/ML model 1404, for example, based on one or more actual RSTD measurements and/or the location information of one or more TRps. he WTRU 1402 may (e.g., further) compute the average of the one or more actual and estimated RSTD measurements over N occasions, and/or the absolute difference between one or more (e.g., two) averaged actual and estimated measurements (e.g., at 1406). For example, averaging the one or more actual and estimated RSTD measurements over N occasions, and/or the absolute difference between one or more (e.g., two) averaged actual and estimated measurements may reduce one or more errors in AI/ML estimation and/or measurements (e.g., at 1406). At 1408, for example, the WTRU 1402 may report the one or more actual measurements to the network, for example, if the error is less or equal to a preconfigured threshold. At 1410, the WTRU may report both actual measurements and associated error to the network, for example, if the error is greater than the preconfigured threshold.

The WTRU may receive one or more configurations for WTRU-based angle-based positioning method (e.g., DL-AoD with TRP locations), N (e.g., number of measurement occasions), threshold, and/or one or more PRS configurations. The WTRU may receive one or more parameters for the AI/ML model. The WTRU may perform one or more measurements on PRS and/or may obtain one or more RSRPs. The WTRU may obtain one or more RSTDs (e.g., estimated RSTDs from the AI/ML model based on measured RSRP measurements and TRP location information). The WTRU may compute an average, for example, based on N occasions of RSTDs measurements and/or one or more inferred RSTDs. The WTRU may compute a difference between one or more averaged RSTD measurements and one or more estimated RSTDs. The WTRU may determine to send a request to the network to switch to indicated Tx TEG, for example, if the difference is larger than a threshold. The WTRU may determine to send RSTD measurements to the network, for example, if the difference is less than the threshold.

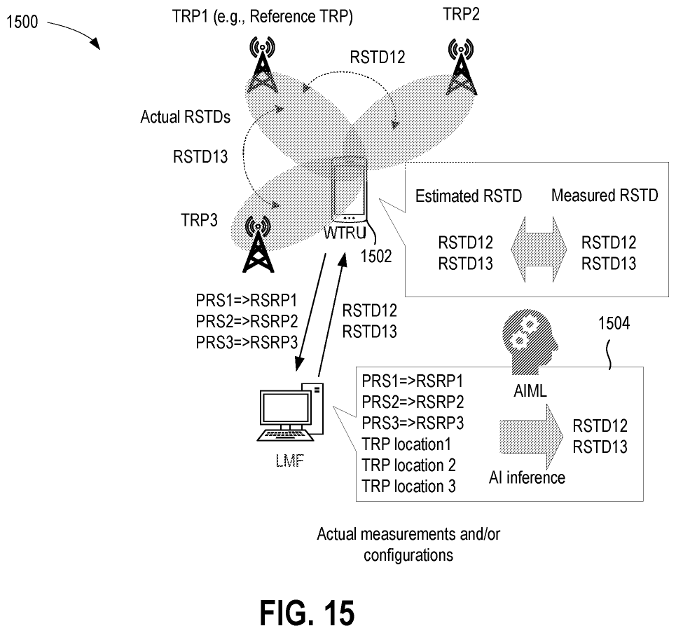

Network-assisted anomaly detection may be performed, as described herein. FIG. 15 illustrates an example system 1500 for of network-assisted anomaly detection. As shown in FIG. 15, the WTRU 1502 may receive one or more estimated measurements from the network based on the one or more actual measurements reported by the WTRU 1502. For example, the WTRU 1502 may report one or more RSRP measurements to the network, and/or the network may determine one or more estimated RSTDs. The network may use an AI/ML model to obtain one or more estimated RSTDs based on one or more actual measurements reported by the WTRU 1502. The AI/ML model may be trained by the network and/or by the WTRU 1502. The network may (e.g., subsequently) indicate to the WTRU 1502 that the WTRU 1502 will receive estimated RSTDs and/or may request to perform anomaly detection in the one or more RSTD measurements. The WTRU 1502 may receive one or more estimated measurements from the network and/or may compute a difference between estimated RSTD and measured RSTD, for example, to determine if there is an anomaly in one or more measurements.

The WTRU 1502 may use the information provided in the network assistance to train the anomaly detector AI/ML model at the WTRU, for example, to support one or more of the procedures described herein.

The WTRU 1502 may include a quality indication in a measurement report. The WTRU 1502 may perform one or more measurements on one or more configured TRPs. The WTRU may determine to perform one or more measurements on one or more TRPs which are in LOS with respect to the WTRU 1502. The WTRU 1502 may determine that the one or more TRPs are in an LOS relationship with the WTRU 1502 based on one or more measurements (e.g., RSTD, RSRP) and/or indication from the network.

The WTRU 1502 may determine that one or more RSRP measurements that the WTRU 1502 obtained from one or more PRSs transmitted from one or more TRPs are not sufficient to determine its location. Additionally or alternatively, the WTRU 1502 may determine that one or more (e.g., the number of) measurements and/or one or more (e.g., number of) observed TRPs is below a configured threshold (e.g., minimum number) of measurements and/or TRPs. The WTRU 1502 may use the AI/ML model 1504 to obtain one or more estimated RSRP measurements for one or more unobserved TRPs.

The WTRU 1502 may determine to use the configured AI/ML model 1504 based on one or more of the following (e.g., if one or more of the following conditions is satisfied): one or more (e.g., the number of) NLOS TRPs is above a configured threshold (e.g., where the threshold may be a function of the number of TRPs); the average, minimum or maximum RSRP measurement(s) of TRP(s) is below a configured threshold; and/or the average, minimum or maximum number of paths in the measurement is above a threshold.

The WTRU 1502 may determine to send a request for assistance information (e.g., AI/ML model 1504), for example, if the WTRU is not configured with an AI/ML model 1504 and/or the based on one or more of the conditions herein (e.g., the WTRU 1502 determines that one or more of the conditions herein is satisfied). The WTRU 1502 may determine to include a rough location information in the request, where the location may be determined based on one or more measurements.

One of the parameters of the AI/ML model 1504 may be coverage (e.g., the AI/ML model 1504 may estimate one or more measurements within the coverage). The coverage may be expressed in terms of radius (e.g., in meters), area (e.g., in square meters), predefined area, and/or predefined zone and/or cell (e.g., defined by cell ID).

The AI/ML model 1504 may be associated with the area. The WTRU and/or the network (e.g., LMF, gNB) may determine the AI/ML model 1504 to use and/or send, for example, based on the coarse location information about the WTRU 1502. For example, the WTRU 1502 and/or NW may determine the AI/ML model 1504 whose center of coverage is within the threshold from the coarse location information of the WTRU 1502. In examples, the one or more AI/ML models 1504 may not be associated with area and/or location. In this case, for example, the AI/ML model 1504 may be based on the area of coverage.

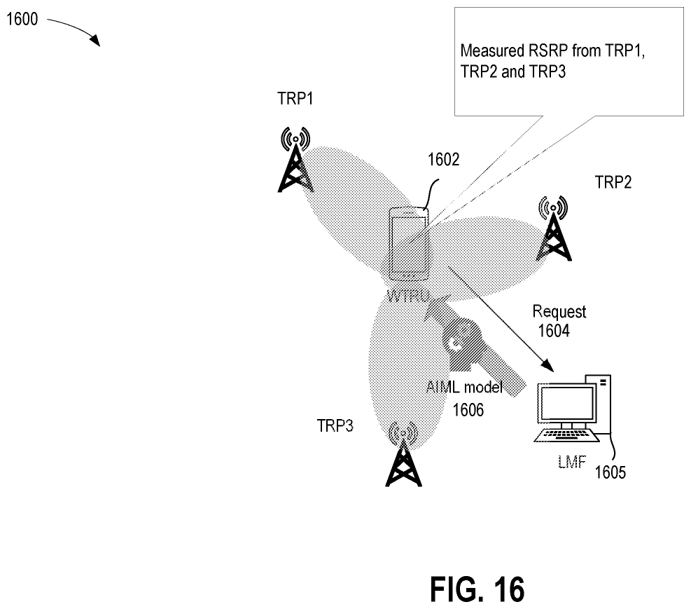

FIG. 16 illustrates an example system 1600 including a WTRU 1602 and a network entity (e.g., LMF 1605) from which requests may be made for receiving assistance information. As shown in FIG. 16, the WTRU 1602 may make one or more measurements on a TRP and/or send a request 1604 to the network (e.g., an LMF) for assistance information 1606 (e.g., AI/ML model and/or one or more parameters thereof). In response to the request 1604, the LMF 1605 may transmit the assistance information comprising the AI/ML model and/or one or more parameters thereof. The assistance information may be based on the measurements performed and/or included in the request 1604. The WTRU may determine the assistance information in the request. For example, the WTRU may determine which assistance information to request from the network. Based on the request, for example, the network may determine the content of assistance information (e.g., AI/ML model index and/or ID) to send (e.g., to be provided) to the WTRU. The one or more AI/ML models may be trained by the network and/or by the WTRU. In examples, the network may have one or more AI/ML models and/or may provide the one or more details of the model parameters (e.g., weights, model index) to the WTRU.

The AI/ML model may be associated with an area and/or cell. The WTRU 1602 may determine that the AI/ML model can estimate one or more measurements (e.g., RSRP) for one or more TRPs within the area. The WTRU 1602 may determine the one or more estimated measurements for the target TRP(s), for example, based on one or more actual measurements made on the one or more TRPs, their locations, and/or the location of target TRP(s).

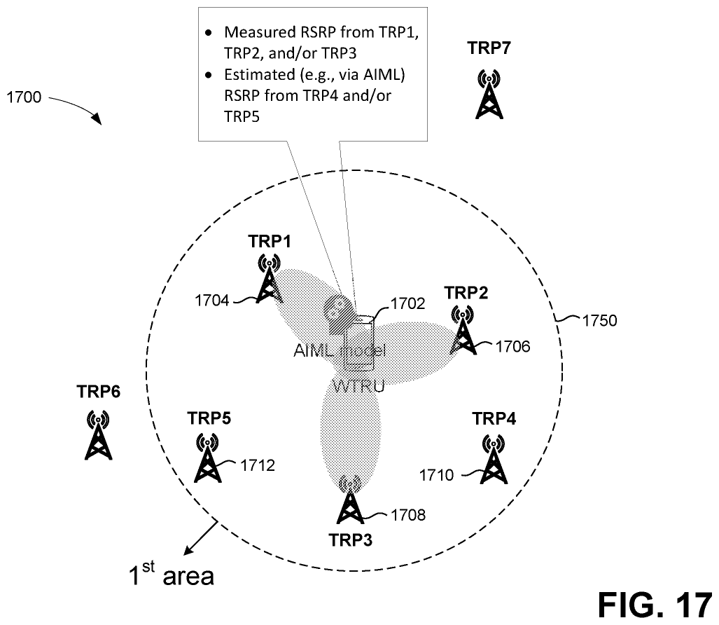

FIG. 17 illustrates an example system 1700 in which a WTRU 1702 may estimate one or more RSRP measurements of unobserved TRP(s) (e.g., unobserved TRPs may be TRPs that are not part of the one or more configurations provided to the WTRU). For example, the WTRU 1702 may estimate one or more RSRP measurements of unobserved TRP(s) (e.g., TRP4 1710 and TRP5 1712 shown in FIG. 17) based on at least RSRP measurements from observed TRPs (e.g., TRP1 1704, TRP2 1706, and/or TRP3 1708 shown in FIG. 17).

The WTRU 1702 may be configured with more than one model, where one or more (e.g., each) models may be associated with a model ID (e.g., model index). One or more (e.g., each) models may correspond to a different size (e.g., number of neurons) of the AI/ML model and/or applicable location, for example, where one or more (e.g., each) models may be associated with an area and/or cell. The WTRU 1702 may receive a model ID from the network, for example, when the WTRU requests a model.

The WTRU 1702 may be configured with an expansion factor associated with the AI/ML model. The WTRU 1702 may determine to extend the area associated with the AI/ML model by an expansion factor, for example, based on one or more of the conditions herein (e.g., if the WTRU 1702 determines that at least one of the following conditions is satisfied): one or more (e.g., the number of) actual and/or estimated measurements is below a threshold; and/or uncertainty associated with location information determined based on actual and/or estimated measurements is below a threshold. For example, the WTRU may determine to extend the area associated with the AI/ML model by an expansion factor r_{new}=r×eₓ, where r_{new} may be the new radius of the area, r may be the radius of the current area, and/or eₓ may be the expansion factor.

The WTRU 1702 may determine to estimate one or more measurements in one or more TRPs in an extended area (e.g., 2^{nd} area). The WTRU 1702 may determine the one or more measurements of TRP within the 2^{nd} area but outside of the 1^{st} area 1750. The WTRU may determine the one or more measurements for the one or more TRPs in the 2^{nd} area, for example, based on one or more actual measurements and/or estimated measurements in the 1^{st} area 1750.

When the WTRU 1702 reports fine location information (e.g., determined based on one or more actual and/or estimated measurements) and/or measurements to the network, the WTRU 1702 may indicate one or more of the following in the report: a quality indication associated with estimated measurement (e.g., Area ID, and/or how many iterations the area has been extended, one or more statistical characteristics such as standard deviation, whether the one or more estimated measurement is associated with the 1^{st} 1750 and/or 2^{nd} area, etc.); and/or a quality indication associated with estimated location information (e.g., how many iterations the area has been extended, whether the one or more estimated measurements from 1^{st} area 1750 and/or 2^{nd} area have been used or not, etc.).

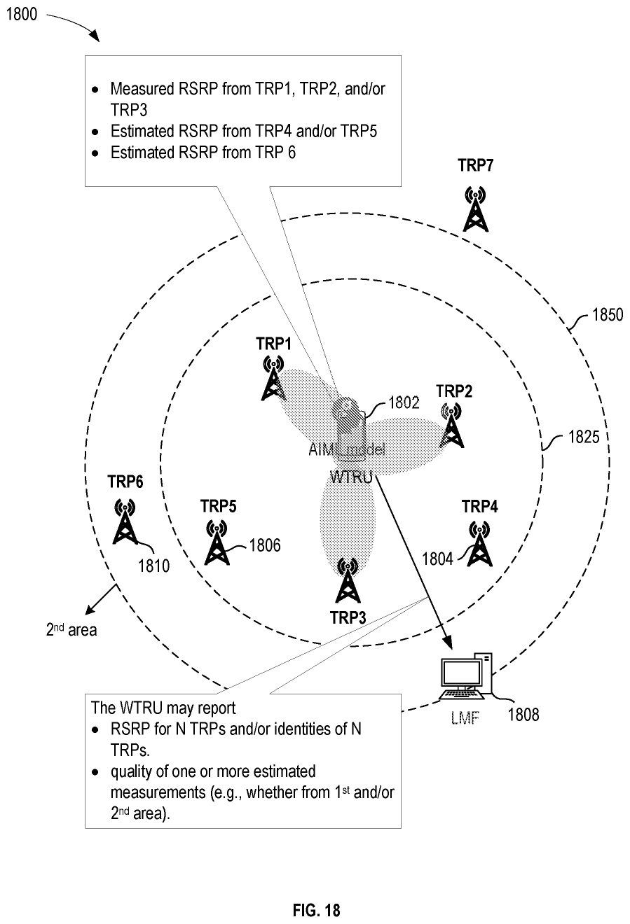

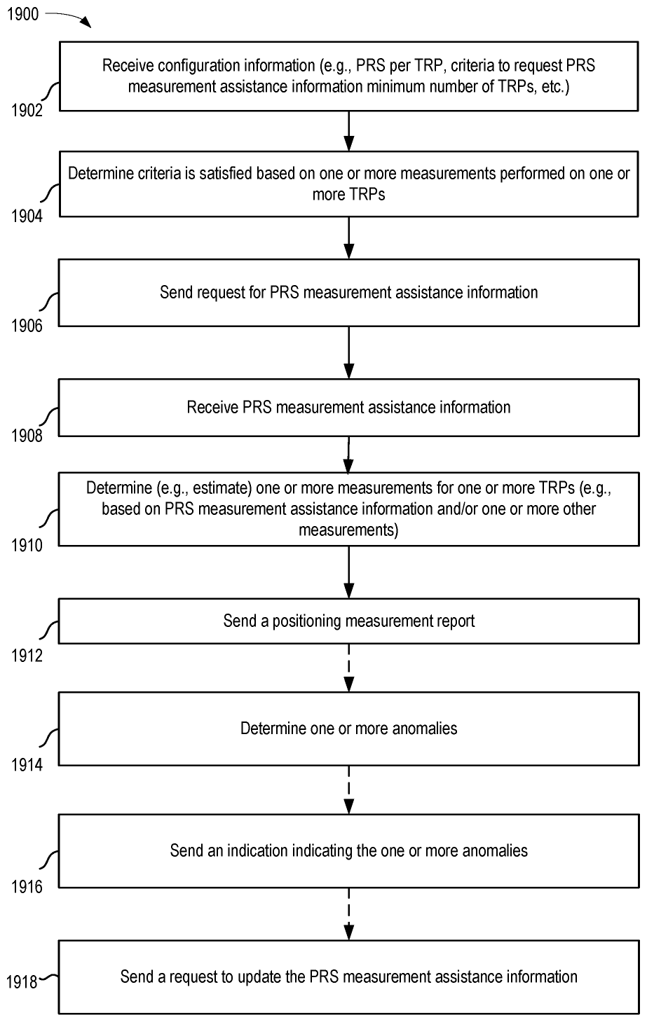

FIG. 18 illustrates an example system 1800 in which a WTRU 1802 may determine one or more RSRP measurements for one or more unobserved TRPs. For example, the WTRU 1802 may determine one or more RSRP measurements for one or more unobserved TRPs (e.g., TRP4 1804 and/or TRP5 1806) in an area (e.g., a 2^{nd} area 1850, which may be an extended area from a 1^{st} area 1825). As shown in FIG. 18, the WTRU 1802 may determine one or more estimated measurements for TRPs (e.g., TRP6 1810) in the 2^{nd} area 1850 but outside of 1^{st} area 1825. The WTRU 1802 may report one or more measurements to the network (e.g., LMF 1808), where the WTRU 1802 may indicate quality information for measurements. A quality indication in the measurement may be useful for the network to determine quality associated with one or more estimated measurements and/or location information (e.g., since quality of one or more estimated measurements may degrade as the area is extended).

For example, a WTRU may receive one or more configurations for a first set of TRPs, where the one or more configurations may include PRS (e.g., PRS resource ID, periodicity), one or more TRP locations, a value N, and/or a threshold (e.g., a function of number of total TRPs) from the network. The WTRU may perform a first set of measurements on PRS (e.g., RSRP) from the first set of TRPs, for example, based on the configuration received from the network. The WTRU may determine its coarse location, for example, based on the one or more measurements made on the first set of TRPs. The WTRU may request assistance information (e.g., AI/ML model), for example, if the WTRU determines that the number of NLOS TRPs is above or equal to a threshold; the request may include the determined coarse WTRU location. The WTRU may obtain the assistance information with the first area and/or the area expansion factor. The WTRU may determine the second set of TRPs, for example, based on the first area associated with the AI/ML model. The WTRU may estimate the RSRP of the target TRPs in the second set of TRPs, for example, based on the first set of measurements, and/or the one or more locations of the first set of TRPs and/or target TRPs. The WTRU may determine to expand the coverage area (e.g., expand to the second area) by an expansion factor, for example, if the total number of measured and/or estimated TRPs (e.g., from the first set of TRPs and/or the target TRPs) is less than N. The WTRU may repeat the procedure, for example, until the WTRU obtains one or more measurements (e.g., RSRP) from N TRPs. The WTRU may determine and/or report a fine WTRU location based on the measurements. The WTRU may (e.g., also) report one or more RSRP measurements and/or the quality of the one or more estimated measurements (e.g., whether from the first and/or second area).

FIG. 19 depicts a process flowchart diagram of an example procedure to determine one or more measurements and/or one or more location measurements.

At 1902, the WTRU may receive configuration information from a network (e.g., LMF, gNB), as described herein. The configuration information may include PRS configuration information for each of a plurality of TRPs. For example, the configuration information may indicate one or more criteria for requesting PRS measurement assistance information. For example, the configuration may indicate a minimum number of TRPs for which one or more PRS measurements are to be reported. For example, the configuration information may include one or more parameters for an AI/ML model. The configuration information may be included in the PRS configuration. The one or more parameters for an AI/ML model may be included in PRS configuration or dedicated AI/ML related configuration and/or the network may indicate to the WTRU how AI/ML related parameters are configured (e.g., via PRS configuration and/or AI/ML dedicated signaling or configuration).

At 1904, the WTRU may determine one or more criteria for requesting PRS measurement assistance information is satisfied, as described herein. For example, the WTRU determine one or more criteria for requesting PRS measurement assistance is satisfied based on one or more measurements performed on one or more of the plurality of TRPs.

At 1906, the WTRU may send a request (e.g., to the network 1904) for the PRS measurement assistance information, as described herein. The WTRU may request the PRS measurement assistance information based on, for example, a determination that one or more of the plurality of TRPs includes non-line of sight TRPs. The request may indicate a location of the WTRU. For example, the request may indicate a location of the WTRU that is determined based on the one or more measurements performed on one or more of the plurality of TRPs.

At 1908, the WTRU may receive the PRS measurement assistance information from the network (e.g., LMF, gNB), as described herein. For example, the WTRU may receive one or more parameters (e.g., one or more weights, PRS configuration for training) for one or more AI/ML models. Additionally or alternatively, the WTRU may receive one or more parameters (e.g., weights, PRS configuration for training) for one or more AI/ML models from the network via receiving configuration information (e.g., via signaling, indication, and/or configuration information associated with the AI/ML model configuration).

At 1910, the WTRU may determine (e.g., estimate) one or more measurements for at least one TRP, as described herein. For example, the WTRU may estimate one or more measurements for at least one TRP based on the PRS measurement assistance information and/or at least one or measurement performed using the PRS configuration information for at least one TRP of the plurality of TRPs. For example, the WTRU may estimate one or more measurements for at least one TRP based on one or more AI/ML models. The WTRU may estimate one or more measurements of a first type of measurement based on one or more actual measurements of a second type of measurement and/or the PRS measurement assistance information. For example, the WTRU may determine a RSRP based on one or more RSRP measurements and/or the PRS measurement assistance information. The WTRU may determine one or more estimated measurements of a relatively lower estimated quality for at least one additional TRP such that the total number of TRPs associated with the actual PRS measurements, associated with the estimated measurements of a relatively higher estimated quality, and/or the estimated measurements of the relatively lower estimated quality is at least the minimum number of TRPs for which measurements are to be reported. The determination of one or more estimated measurements of a relatively lower estimated quality for at least one additional TRP may be responsive to a determination that a total number of TRPs associated with one or more actual PS measurements and/or associated with one or more estimated measurements of a relatively higher estimated quality are less than the minimum number of TRPs for which PRS measurements are to be reported.

At 1912, the WTRU may send a positioning measurement report, as described herein. The positioning measurement report may include a set of PRS measurements performed on a first subset of TRPs of the plurality of TRPs and/or a set of estimated measurements determined for a second subset of TRPs of the plurality of TRPs. The first and/or second subset(s) of TRPs may include a total number of TRPs. For example, the total number of TRPs included in the first and/or second subset of TRPs may be at least the minimum number of TRPs for which PRS measurement(s) are to be reported. In examples, the WTRU may receive an indication of a time window. The WTRU may receive configuration related to the time window in a dedicated configuration and/or PRS configuration. The WTRU may receive an indication from the network which configuration (e.g., between PRS configuration and dedicated window configuration) the WTRU may receive the parameter(s) related to the window. The WTRU may send a first (e.g., positioning) measurement report and/or a second (e.g., positioning) measurement report, for example, based on the time window. The WTRU may include one or more measurements (e.g., RSTD, RSRP, time of flight, ToA, Rx-Tx time difference) in the first and/or second measurement report(s).

At 1914, the WTRU may determine one or more anomalies, as described herein, associated with the set of PRS measurements performed on the first subset of TRPs of the plurality of TRPs and/or the set of estimated measurements determined for the second subset of TRPs of the plurality of TRPs.

At 1916, the WTRU may send an indication to a network (e.g., as described herein) indicating the one or more anomalies associated with the set of PRS measurements performed on the first subset of TRPs of the plurality of TRPs and/or the set of estimated measurements determined for the second subset of TRPs of the plurality of TRPs.

At 1918, the WTRU may send a request (e.g., as described herein) to update the PRS measurement assistance information to estimate one or more measurements for at least one TRP.

The processes and instrumentalities described herein may apply in any combination, may apply to other wireless technologies, and for other services.

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed is:

1.-20. (canceled)

21. A wireless transmit/receive unit (WTRU) comprising:
a processor configured to:
receive configuration information, wherein the configuration indicates positioning reference signal (PRS) configuration information for each of a plurality of transmission/reception points (TRPs), wherein the configuration information indicates one or more criteria for requesting PRS measurement assistance information, and wherein the configuration information indicates a minimum number of TRPs for which one or more PRS measurements are to be reported;
determine that at least one criteria of the one or more criteria for requesting the PRS measurement assistance information is satisfied based on one or more measurements performed on one or more of the plurality of TRPs;
send a request for the PRS measurement assistance information, wherein the request indicates a location of the WTRU that is determined based on the one or more measurements performed on one or more of the plurality of TRPs;
receive the PRS measurement assistance information, the PRS measurement assistance information comprising one or more artificial intelligence/machine learning (AI/ML) model parameters;
estimate one or more measurements for at least one TRP based on the one or more AI/ML model parameters and at least one measurement performed using the PRS configuration information for at least one TRP of the plurality of TRPs; and
send a positioning measurement report, wherein the positioning measurement report comprises a set of PRS measurements performed on a first subset of TRPs of the plurality of TRPs and a set of estimated measurements determined for a second subset of TRPs of the plurality of TRPs, wherein a total number of TRPs included in the first and second subsets of TRPs is at least the minimum number of TRPs for which PRS measurements are to be reported.

22. The WTRU of claim 21, wherein the processor is further configured to determine an estimated measurement of a first type of measurement based on one or more actual measurements of a second type of measurement and the PRS measurement assistance information.

23. The WTRU of claim 21, wherein the processor is further configured to determine one or more estimated measurements of a relatively lower estimated quality for at least one additional TRP such that the total number of TRPs associated with actual PRS measurements, associated with the estimated measurements of a relatively higher estimated quality, or the estimated measurements of the relatively lower estimated quality is at least the minimum number of TRPs for which measurements are to be reported;
wherein the determination of one or more estimated measurements of a relatively lower estimated quality for at least one additional TRP is responsive to a determination that a total number of TRPs associated with one or more actual PRS measurements or associated with one or more estimated measurements of a relatively higher estimated quality are less than the minimum number of TRPs for which PRS measurements are to be reported.

24. The WTRU of claim 21, wherein the processor is further configured to request the PRS measurement assistance information based on a determination that the one or more of the plurality of TRPs comprises non-line of sight TRPs.

25. The WTRU of claim 21, wherein the processor is further configured to determine a Reference Signal Time Difference (RSTD) based on one or more reference signal received power (RSRP) measurements and the PRS measurement assistance information.

26. The WTRU of claim 25, wherein, to send the positioning measurement report, the processor is configured to send the determined RSTD or the one or more RSRP measurements for each TRP of the first or second subset of TRPs of the plurality of TRPs.

27. The WTRU of claim 21, wherein the processor is further configured to:
receive an indication of a time window; and
send a first measurement report or a second measurement report based on the time window.

28. The WTRU of claim 21, wherein the processor is configured to determine one or more anomalies associated with the set of PRS measurements performed on the first subset of TRPs of the plurality of TRPs or one or more anomalies associated with the set of estimated measurements determined for the second subset of TRPs of the plurality of TRPs.

29. The WTRU of claim 28, wherein the processor is further configured to send an indication to a network indicating the one or more anomalies associated with the set of PRS measurements performed on the first subset of TRPs of the plurality of TRPs or the set of estimated measurements determined for the second subset of TRPs of the plurality of TRPs.

30. The WTRU of claim 21, wherein the processor is further configured to send a request to update the PRS measurement assistance information to estimate one or more measurements for at least one TRP.

31. A method performed by a wireless transmit/receive unit (WTRU), the method comprising:
receiving configuration information, wherein the configuration indicates positioning reference signal (PRS) configuration information for each of a plurality of transmission/reception points (TRPs), wherein the configuration information indicates one or more criteria for requesting PRS measurement assistance information, and wherein the configuration information indicates a minimum number of TRPs for which one or more PRS measurements are to be reported;
determining that at least one criteria of the one or more criteria for requesting the PRS measurement assistance information is satisfied based on one or more measurements performed on one or more of the plurality of TRPs;
sending a request for the PRS measurement assistance information, wherein the request indicates a location of the WTRU that is determined based on the one or more measurements performed on one or more of the plurality of TRPs;
receiving the PRS measurement assistance information, the PRS measurement assistance information comprising one or more artificial intelligence/machine learning (AI/ML) model parameters;
estimating one or more measurements for at least one TRP based on the one or more AI/ML model parameters and at least one measurement performed using the PRS configuration information for at least one TRP of the plurality of TRPs; and
sending a positioning measurement report, wherein the positioning measurement report comprises a set of PRS measurements performed on a first subset of TRPs of the plurality of TRPs and a set of estimated measurements determined for a second subset of TRPs of the plurality of TRPs, wherein a total number of TRPs included in the first and second subsets of TRPs is at least the minimum number of TRPs for which PRS measurements are to be reported.

32. The method of claim 31, further comprising determining an estimated measurement of a first type of measurement based on one or more actual measurements of a second type of measurement and the PRS measurement assistance information.

33. The method of claim 31, further comprising determining one or more estimated measurements of a relatively lower estimated quality for at least one additional TRP such that the total number of TRPs associated with actual PRS measurements, associated with the estimated measurements of a relatively higher estimated quality, or the estimated measurements of the relatively lower estimated quality is at least the minimum number of TRPs for which measurements are to be reported;
wherein the determination of one or more estimated measurements of a relatively lower estimated quality for at least one additional TRP is responsive to a determination that a total number of TRPs associated with one or more actual PRS measurements or associated with one or more estimated measurements of a relatively higher estimated quality are less than the minimum number of TRPs for which PRS measurements are to be reported.

34. The method of claim 31, further comprising requesting the PRS measurement assistance information based on a determination that the one or more of the plurality of TRPs comprises non-line of sight TRPs.

35. The method of claim 31, further comprising determining a Reference Signal Time Difference (RSTD) based on one or more reference signal received power (RSRP) measurements and the PRS measurement assistance information.

36. The method of claim 35, wherein sending the positioning measurement report comprises sending the determined RSTD or the one or more RSRP measurements for each TRP of the first or second subset of TRPs of the plurality of TRPs.

37. The method of claim 31, further comprising:
receiving an indication of a time window; and
sending a first measurement report or a second measurement report based on the time window.

38. The method of claim 31, further comprising determining one or more anomalies associated with the set of PRS measurements performed on the first subset of TRPs of the plurality of TRPs or one or more anomalies associated with the set of estimated measurements determined for the second subset of TRPs of the plurality of TRPs.

39. The method of claim 38, further comprising sending an indication to a network indicating the one or more anomalies associated with the set of PRS measurements performed on the first subset of TRPs of the plurality of TRPs or the set of estimated measurements determined for the second subset of TRPs of the plurality of TRPs.

40. The method of claim 31, further comprising sending a request to update the PRS measurement assistance information to estimate one or more measurements for at least one TRP.
